(19) United States
(12) Patent Application Publication
(10) Pub. No.: US 2018/0053240 A1
(43) Pub. Date: Feb. 22, 2018

(54) SYSTEMS AND METHODS FOR DELIVERING REQUESTED MERCHANDISE TO CUSTOMERS

(71) Applicant: Wal-Mart Stores, Inc., Bentonville, AR (US)

(72) Inventors: Nicholaus A. Jones, Fayetteville, AR (US); Starla C. Morgan, Bentonville, AR (US); Todd D. Mattingly, Bentonville, AR (US); Bruce W. Wilkinson, Rogers, AR (US)

(21) Appl. No.: 15/678,608

(22) Filed: Aug. 16, 2017

Related U.S. Application Data
(60) Provisional application No. 62/377,298, filed on Aug. 19, 2016.
(60) Provisional application No. 62/381,793, filed on Aug. 31, 2016.
(60) Provisional application No. 62/445,552, filed on Jan. 12, 2017.
(60) Provisional application No. 62/436,842, filed on Dec. 20, 2016.
(60) Provisional application No. 62/485,045, filed on Apr. 13, 2017.

(51) Int. Cl. G06Q 30/06; G06Q 10/08

(52) U.S. Cl. CPC G06Q 30/0635; G06Q 10/083

(57) ABSTRACT

In some embodiments, apparatuses and methods are provided herein useful to delivering requested merchandise to customers. In some embodiments, there is provided a system for locating customers in shopping facilities including: an electronic interface configured to receive a customer's request for a product at a shopping facility; at least one sensor configured to determine and monitor the customer's location in the shopping facility; and a control circuit configured to: identify the product requested by the customer; initiate a determination if the product is present at the shopping facility; if the product is present, provide an instruction to collect the product; determine the location of the customer in the shopping facility; monitor the location of the customer as the customer moves through the shopping facility; and instruct delivery of the collected product to the customer in the shopping facility.

### RELATED APPLICATION(S)

This application claims the benefit of U.S. Provisional Application No. 62/377,298, filed Aug. 19, 2016, U.S. Provisional Application No. 62/381,793, filed Aug. 31, 2016, U.S. Provisional Application No. 62/445,552, filed Jan. 12, 2017, U.S. Provisional Application No. 62/436,842, filed Dec. 20, 2016, and U.S. Provisional Application No. 62/485,045, filed Apr. 13, 2017, which are all incorporated by reference in their entirety herein.

### TECHNICAL FIELD

These teachings relate generally to providing products and services to individuals.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

### BRIEF DESCRIPTION OF THE DRAWINGS

The above needs are at least partially met through provision of the vector-based characterizations of products described in the following detailed description, particularly when studied in conjunction with the drawings, wherein:

FIG. 1 is a block diagram in accordance with several embodiments;

FIG. 2 is a flow diagram in accordance with several embodiments;

FIG. 3 comprises a flow diagram as configured in accordance with various embodiments of these teachings;

FIG. 4 comprises a flow diagram as configured in accordance with various embodiments of these teachings;

FIG. 5 comprises a graphic representation as configured in accordance with various embodiments of these teachings;

FIG. 6 comprises a graph as configured in accordance with various embodiments of these teachings;

FIG. 7 comprises a flow diagram as configured in accordance with various embodiments of these teachings;

FIG. 8 comprises a graphic representation as configured in accordance with various embodiments of these teachings;

FIG. 9 comprises a graphic representation as configured in accordance with various embodiments of these teachings;

FIG. 10 comprises a graphic representation as configured in accordance with various embodiments of these teachings;

FIG. 11 comprises a flow diagram as configured in accordance with various embodiments of these teachings;

FIG. 12 comprises a flow diagram as configured in accordance with various embodiments of these teachings;

FIG. 13 comprises a graphic representation as configured in accordance with various embodiments of these teachings;

FIG. 14 comprises a graphic representation as configured in accordance with various embodiments of these teachings;

FIG. 15 comprises a block diagram as configured in accordance with various embodiments of these teachings;

FIG. 16 comprises a flow diagram as configured in accordance with various embodiments of these teachings;

FIG. 17 comprises a graph as configured in accordance with various embodiments of these teachings;

FIG. 18 comprises a flow diagram as configured in accordance with various embodiments of these teachings;

FIG. 19 comprises a block diagram as configured in accordance with various embodiments of these teachings;

FIG. 20 is a flow diagram in accordance with several embodiments;

FIG. 21 is a block diagram in accordance with several embodiments;

FIG. 22 is a flow diagram in accordance with several embodiments;

FIG. 23 illustrates a simplified block diagram of an exemplary retail customization system that provides customized virtual retail shopping experiences to multiple customers, in accordance with some embodiments;

FIG. 24 illustrates an exemplary system for use in implementing methods, techniques, devices, apparatuses, systems, servers, sources and providing a customized shopping experience, in accordance with some embodiments;

FIG. 25 illustrates a simplified block diagram of an exemplary process of providing a customized retail shopping experience for customers at a shopping facility, in accordance with some embodiments;

FIG. 26 comprises a block diagram as configured in accordance with various embodiments of these teachings;

FIG. 27 comprises a flow diagram as configured in accordance with various embodiments of these teachings; and

FIG. 28 comprises a schematic screen shot as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

In a first form that may use these partiality vectors and vectorized characterizations, systems, apparatuses and methods are provided herein useful to delivering requested merchandise to customers. In one form, there is provided a system for locating customers in shopping facilities including: an electronic interface configured to receive a customer's request for a product at a shopping facility; at least one sensor configured to determine and monitor the customer's location in the shopping facility; a control circuit operatively coupled to the electronic interface and the at least one sensor, the control circuit configured to: identify the product requested by the customer; initiate a determination if the product is present at the shopping facility; if the product is present, provide an instruction to collect the product; determine the location of the customer in the shopping facility; monitor the location of the customer as the customer moves through the shopping facility; and instruct delivery of the collected product to the customer in the shopping facility.

In one form, the electronic interface may include a mobile device configured to: scan a product identification label at a shelf in the shopping facility intended to contain the product; and provide notification that the product is not available at the shelf. Further, the electronic interface may include a kiosk at the shopping facility configured to receive the customer's request for the product. In addition, the electronic interface may include a server at the shopping facility configured to receive the customer's request for the product.

In one form, the at least one sensor may include at least one image capture device configured to identify the customer and monitor the movement of the customer in the shopping facility. Further, the at least one sensor may include an array of audio sensors arranged in a predetermined pattern in the shopping facility and configured to identify the customer and monitor the movement of the customer in the shopping facility. In addition, where the system includes a mobile device, the mobile device may include monitoring software and may be configured to transmit a monitoring signal; and the at least one sensor may include a Wi-Fi positioning system configured to receive the monitoring signal and determine the location of the mobile device in the shopping facility.

In one form, in the system, if the product is not present at the shopping facility, the control circuit may be configured to identify a substitute product. Further, the control circuit may be configured to access a database and identify the substitute product by at least one of: selecting the substitute product from other products in the same category as the requested product; and selecting the substitute product from other products previously purchased by the customer.

In one form, the control circuit may be configured to identify a substitute product by: accessing partiality information for the customer and using that partiality information to form corresponding partiality vectors for the customer wherein the partiality vector has a magnitude that corresponds to a magnitude of the customer's belief in an amount of good that comes from an order associated with that partiality. Further, the control circuit may be configured to identify the substitute product by: forming counterpart product vectors for products wherein the counterpart vectors have a magnitude that represents the degree to which each of the products pursues a corresponding partiality. In addition, the control circuit may be configured to identify the substitute product by: using at least one of the partiality vectors and the product vectors to determine a product that accords with a given customer's own partialities and identifying that product as the substitute product.

In one form, in the system, if the product is not present at the shopping facility, the control circuit may be configured to communicate to the customer through the electronic interface the option of delivery of the product to the customer's residence or the option of customer pick of the product at a future time. Further, if the product is present, the control circuit may be configured to inform the customer through the electronic interface that the product will be delivered to the customer in the shopping facility. In addition, the control circuit may be configured to transmit a current location of the customer to a shopping facility employee collecting the product.

In another form, there is provided a method for locating customers in shopping facilities including: receiving, by an electronic interface, a customer's request for a product at a shopping facility; determining and monitoring, by at least one sensor, the customer's location in the shopping facility; by a control circuit: identifying the product requested by the customer; initiating a determination if the product is present at the shopping facility; if the product is present, providing an instruction to collect the product; determining the location of the customer in the shopping facility; monitoring the location of the customer as the customer moves through the shopping facility; and instructing delivery of the collected product to the customer in the shopping facility.

In another form, there is provided a system for delivering products to customers in shopping facilities including: an electronic interface configured to receive a customer's request for a product at a shopping facility; a control circuit operatively coupled to the electronic interface, the control circuit configured to: identify the product requested by the customer; initiate a determination if the product is present at the shopping facility; if the product is present, provide an instruction to collect the product; receive a communication from the customer identifying a rendezvous location in the shopping facility; and instruct delivery of the collected product to the customer at the rendezvous location.

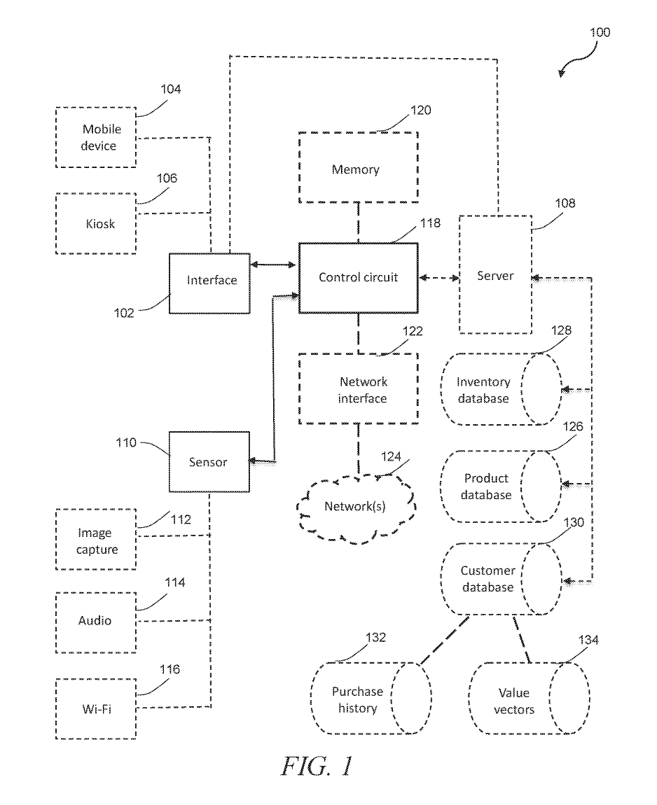

Referring to FIG. 1, there is shown a system 100 for delivering a merchandise item in a shopping facility. Generally, it is contemplated that a customer may seek merchandise at a shelf in the shopping facility, but the shelf may be out of stock. The customer may then request the item through an electronic interface, and it will then be determined whether the merchandise may be available at another location in the shopping facility, such as in a back room or storage room. Assuming the merchandise is available, an employee may then collect and deliver the merchandise item to the customer, who has agreed to the convenience of an in-store delivery and has therefore been monitored as he or she continued with other purchases at the shopping facility.

As shown in FIG. 1, the system 100 includes an electronic interface 102 configured to receive a customer's request for a product at a shopping facility. It is contemplated that any of various types of electronic interfaces 102 may be used by customers in various ways. For example, in one form, the electronic interface 102 may be a mobile device 104 that is configured to scan a product identification label at a shelf in the shopping facility intended to contain the product. So, in this form, a customer may approach a shelf at the shopping facility and determine that the shelf is empty (does not contain any merchandise). The customer may be interested in determining whether the merchandise is present at some other location in the shopping facility but may not be inclined to search for an available employee to assist the customer. This additional step may represent a barrier to purchase to the customer, and the customer may decide that he or she is not interested in expending this additional effort. In this example, the customer may use a mobile device 104 to scan a product identification label and provide notification that the product is not available at the shelf.

In this example, the mobile device 104 (such as a smartphone or computer tablet) may be the user's own personal mobile device or may be a mobile device supplied by the shopping facility. In one form, it is contemplated that the user may use the mobile device 104 with a software application to access a server 108 at the shopping facility to indicate that the merchandise is not available at the shelf. It is contemplated that the user may transmit information identifying the product and may also transmit information identifying the customer. In this form, as described further below, it is contemplated that the server 108 may communicate back to the customer via the electronic interface 102 (such as mobile device 104) that the product is (or is not) available at the shopping facility and that an employee will (or will not be able to) deliver the product to the customer at the shopping facility.

In another form, the electronic interface 102 may be a kiosk 106 at the shopping facility. In other words, the electronic interface 102 may be a kiosk 106 positioned within a shopping facility and configured to access data on products. The kiosk 106 may enable the customer to both input information and to experience product information on an audiovisual display. For example, the kiosk 106 may include a touch screen configured to access product data and may include three-dimensional or four-dimensional stereoscopic film technology configured for customer perception of the products, such as on an audiovisual display. In this form, the kiosk 106 may provide the customer with an enhanced viewing experience. The customer may request a product (and may input customer information). Again, it is contemplated that a server 108 may communicate back to the customer via the kiosk 106 that the product is (or is not) available at the shopping facility and that an employee will (or will not be able to) deliver the product to the customer at the shopping facility. In this instance, it is contemplated that the product may be available on a shelf but that the customer has opted for a convenient in-store delivery of the requested product to the customer.

In another form, it is contemplated that the electronic interface 102 may be a server 108. In one form, it is contemplated that a customer may make a customer request remotely, i.e., outside of a shopping facility, to provide product identification information (and possibly customer identification information), such as via the internet from a customer's residence. For example, the customer or potential information may access a server 108 remotely, such as from a computing device at the individual's residence. In this instance, it is contemplated that the server 108 includes an electronic interface configured to receive the information inputted by the customer and to make the requested product available for an in-store delivery, possibly during the customer's next shopping excursion. However, it should also be understood that a server 108 at the shopping facility may be considered to be an electronic interface 102 configured to receive a customer's request for a product where that request is made at the shopping facility. In other words, the server 108 may be an electronic interface 102 configured to receive a customer's request for delivery of a product at a shopping facility where the request is not made remotely but is made at the shopping facility (such as by receiving the request from the customer's own mobile device).

The system 100 also includes sensor(s) 110 configured to determine and monitor the customer's location in the shopping facility. It is generally contemplated that, after the customer makes a request for a product, the customer will be able to continue on with his or her shopping experience. The system 100 includes sensors(s) 110 so that the customer's location in the shopping facility may be monitored so that the merchandise may be delivered to the customer without interrupting the customer's shopping experience. This in-store delivery provides a convenience to the customer by not requiring any special effort to remember to pick up the merchandise at a specific time at a specific location, which may also interfere with the customer's plans and schedule.

The sensor(s) 110 may be of various types and arrangements sufficient to monitor the location of the customer in the shopping facility. In one form, the sensor(s) may be image capture device(s) 112 configured to identify the customer and monitor the movement of the customer in the shopping facility. The image capture device(s) 112 may be any of various kinds of cameras and video analytic equipment that may be arranged about the shopping facility. In one form, an image capture device 112 may be oriented toward the shelves (and possibly kiosks) and, when a customer makes a request for a product and agrees to an in-store delivery, the image capture device 112 may take a still image or a sequence of images that may be used for identification purposes. Later, when the merchandise has been collected (such as from a storage room), the system 100 may determine the current location of the identified customer, as described further below, and may transmit an image to an employee, so as to enable in-store delivery of the product. In one form, the shopping facility may include a specific pattern or arrangement of image capture device(s) 112 so as to cover all (or many) of the shelves in the shopping facility. Further, in one form, the system 100 may use any of various types of image recognition software to assist with the identification and location determination aspects.

In another form, the sensor(s) 110 may include an array of audio sensors 114 arranged in a predetermined pattern in the shopping facility and configured to identify the customer and monitor the movement of the customer (or of a cart) in the shopping facility. For example, a predetermined array of audio sensors 114 may be arranged about a predetermined area of the shopping facility. Indeed, the array may be arranged throughout much of the entire shopping facility. The array of sensors is arranged to receive a sound (audio signal) associated with the customer (or shelf or kiosk where the customer may be requesting the product) and to identify the location of the customer within the shopping facility. This location is preferably communicated to a server 108 within or remote from the shopping facility. The array of audio sensors 114 may be a single sensor or may be multiple sensors and may be arranged in various patterns.

For example, the audio sensors 114 may be microphones that are arranged to receive an audio signal, which may be triggered by the customer at the shelf or kiosk or by a cart. The audio signal may be pitched to be generally inaudible to customers so as not to disturb customers engaged in shopping activities. The array of microphones may be arranged to triangulate the specific location of the customer. In one form, this triangulation may be determined from the specific microphones that detect the audio signal and the intensity of the audio signal at the various microphones.

Alternatively, each shelf, kiosk, or cart may include a speaker (or other sound emitter) that is set up to emit a specific frequency (which may be inaudible so as not to disturb customers) to distinguish that specific location from other shelves and kiosks. In turn, this specific frequency may be used to identify the specific location of the customer when the specific frequency is detected by an audio sensor 114. In this form, a lesser number of audio sensors 114 may be needed, and they may not need to be arranged in any specific pattern so as to triangulate the audio signal.

In some forms, it is contemplated that the audio signal may be an anonymous signal. In other words, it is not required that the audio signal determine the specific identity of the customer. For example, the audio sensors 114 may monitor sounds that the customer makes as the customer (or his or her cart) move through the shopping facility. As another example, an anonymous signal may be from the customer's mobile device (such as addressed below) or from some other device the customer may be carrying.

In another form, the sensor(s) 110 may be in the form of a wireless in-store network (Wi-Fi) 116 that may connect to a customer's mobile device. More specifically, the customer may have a mobile device that includes monitoring software and is configured to transmit a monitoring signal. In this form, it is contemplated that the customer has agreed to the convenience an in-store delivery where the customer's location is determined by the monitoring signal. In this example, the sensor 112 is in the form of a Wi-Fi positioning system 116 configured to receive the monitoring signal and to determine the location of the mobile device in the shopping facility. So, in this manner, when the merchandise has been collected, an employee may determine the current position of the customer's mobile device and may then deliver the merchandise to the customer in the shopping facility. Although some types of sensors have been addressed, it is contemplated that other sensor types may also be used, such as, without limitation, navigational beacons or RFID tags arranged on shelves or carts.

The system 100 also includes a control circuit 118 that is coupled to the electronic interface 102 and the sensor(s) 112 and receives product information from the interface 102 and data from the sensor(s) 112. From this information, as addressed below, the control circuit 118 identifies the product requested by the customer; initiates a determination if the product is present at the shopping facility; if the product is present, provides an instruction to collect the product; determines the location of the customer in the shopping facility; monitors the location of the customer as the customer moves through the shopping facility; and instructs delivery of the collected product to the customer in the shopping facility.

As described herein, the language “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 118 may be configured (for example, by using corresponding programming stored in a memory as will be well understood by those skilled in the art) to carry out one or more of the steps, actions, and/or functions described herein.

As shown in FIG. 1, the control circuit 118 may be coupled to a memory 120, a network interface 122, and network(s) 124. The memory 120 can, for example, store non-transitorily computer instructions that cause the control circuit 118 to operate as described herein, when the instructions are executed, as is well known in the art. Further, the network interface 122 may enable the control circuit 118 to communicate with other elements (both internal and external to the system 100). This network interface 122 is well understood in the art. The network interface 122 can communicatively couple the control circuit 118 to whatever network or networks 124 may be appropriate for the circumstances.

In one form, it is contemplated that the control circuit 118 may access one or more databases to collect data for performing its functions. It may access these databases through a server 108 (such as a shopping facility server or remote server), and/or the server 108 may be considered to form part of the control circuit 118. For example, the control circuit 118 may identify a product requested by a customer (such as by the customer scanning a product identification label or by inputting product identification information at a kiosk) by accessing a product database 126 to determine the product corresponding to that identification label or information. Further, the control circuit 118 may initiate a determination if the product is present at the shopping facility by accessing an inventory database 128 to determine the amount and/or location of the requested merchandise in the shopping facility. Alternatively, the control circuit 118 may initiate this determination by creating a task or instruction for an employee to check a storage room or other room for the requested merchandise. The control circuit 118 may also be configured to create a task/instruction for an employee to collect the product (such as from a storage room) and/or transmit a communication to an employee regarding this task/instruction. The control circuit 118 uses the sensor data to determine and monitor the location of the customer as the customer moves through the shopping facility. This monitoring may include continual monitoring as the customer moves through the shopping facility or may include monitoring at a discrete point in time when the product is ready for in-store delivery. The control circuit 118 may then create and communicate a task/instruction to an employee informing the employee of the current location of the customer in the shopping facility and instructing delivery of the collected product to this current location.

If the product is present in the shopping facility, the control circuit 118 may be configured to confirm in-store delivery of the product to the customer. In other words, the control circuit 118 may be configured to inform the customer through the electronic interface 102 that the product will be delivered to the customer in the shopping facility. If the product is not present at the shopping facility, the control circuit 118 may be configured to communicate the option of delivering the product to the customer's residence or the option of customer pick of the product at the shopping facility at a future time. In this form, the customer's residence information may be available from a customer database 130. Alternatively, the customer may input the customer's residence or a time for a future pick-up via the electronic interface 102.

Further, in another form, the control circuit 118 may be configured to provide for delivery at a different shopping facility. For example, the control circuit 118 may be configured to communicate the option of delivery at another shopping facility and may allow the customer to enter information regarding the desired shopping facility and possibly a time for future pick up at that shopping facility. The requested product may then be delivered to the customer when he or she arrives at the desired shopping facility. As another example, the customer may request or agree to some manner of identification in order to facilitate future delivery at another shopping facility. The control circuit 118 may work in cooperation with the monitoring software of a customer's mobile device or may use image recognition software to identify the customer. The control circuit 118 may then communicate this information to other shopping facilities or to a remote (possibly cloud based) computing platform in communication with certain other shopping facilities. When the customer arrives at one of these other shopping facilities, the customer or his mobile device may be identified, and the requested product may be delivered to the customer.

In another form, it is contemplated that the control circuit 118 may be configured to display an alternate location within the shopping facility where the requested product may be available. In this form, the requested product may be displayed and available at multiple locations within a shopping facility. For example, a mobile device charger may be stocked at both an electronics department within the shopping facility and at an automotive department within the same shopping facility. So, if the customer finds that the shelf in the electronic department is empty, the control circuit 118 may communicate with the customer and re-direct the customer to the automotive department. In other words, if the requested product is in another location accessible to the customer, then the control circuit 118 can show this alternate location to the customer or direct the customer to this alternate location.

In another form, it is also contemplated that the control circuit 118 may be configured to identify a substitute product if the requested product is determined to not be present at the shopping facility or cannot be located. For example, the control circuit 118 may access the inventory database 128, which may indicate that there is no requested merchandise on hand at the shopping facility. In this circumstance, the control circuit 118 may identify a substitute product and may communicate this suggested substitute to the customer, such as via the electronic interface 102. If the customer approves, this substitute product may then be delivered to the customer in the shopping facility by an employee. The control circuit 118 may create a task/instruction to an employee to deliver the substitute product to the current location of the customer in the shopping facility.

It is contemplated that this substitute product may be selected in various ways. For example, the substitute product may be selected from other products in the same category as the requested product. So, if the requested product is one type of cereal, the substitute product may be another type of cereal. As another example, the control circuit 118 may access a customer database 130 and may select the substitute product from products previously purchased by the customer as shown in a purchase history sub-database 132. So, if the requested product is one type of cereal, the substitute product may be another cereal or breakfast item previously purchased by the customer. In one form, this selection may also combine these two approaches by selecting a substitute product that is in the same category as the requested product but that also has a purchase history. In another form, it is contemplated that a substitute product may be selected using a customer sub-database 134 by using the concept of “value vectors” (which is explained in greater detail below).

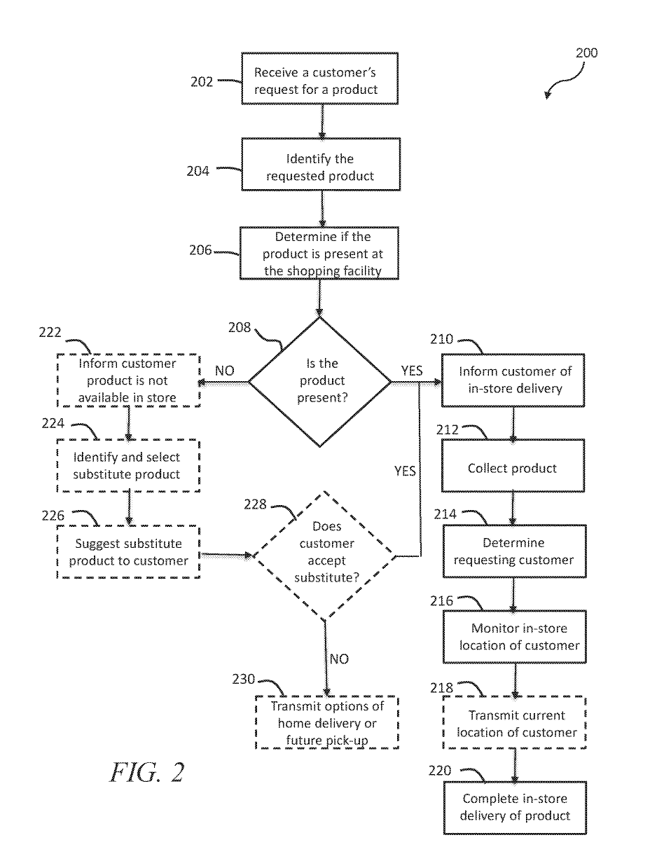

Referring to FIG. 2, there is shown a process 200 that may use the system 100 or some of the components thereof. It is generally contemplated that the process 200 may conveniently provide a requested merchandise item to a customer without interrupting the customer's shopping experience at a shopping facility. It is contemplated that sensor(s) may monitor the customer in the shopping facility so that an employee may find the customer and provide the customer with the requested item or a substitute item.

At block 202, the customer may input a request for a product (such as via a mobile device or at a shopping facility kiosk), and this request may be received (such as by a server at the shopping facility). At block 204, the product is identified. For example, a customer may scan a product identification label with a mobile device and transmit this information to a shopping facility server (where the product is identified). In one form the product may be identified by consulting a product database. At block 206, a determination is made if the product is present at the shopping facility. In one form, this determination may be made by consulting an inventory database to determine how much merchandise is shown to be on hand at the shopping facility. In another form, it is contemplated that an employee may be instructed to check a back room or storage room to determine if the requested merchandise is at these locations.

At block 208, a determination is made whether the product is present at the shopping facility. If the product is present, the process 200 proceeds along the right hand path of FIG. 2. At block 210, the customer may be informed that the product is available at the shopping facility and that the product will be delivered to the customer at the store (without interrupting the customer's continued shopping). At block 212, an employee collects the product from the storage room or other alternative location of the merchandise. The product is ready for in-store delivery to the customer. It should be understood that, although the steps are shown in one particular sequence, they can be performed in a different sequence or possibly not at all. For example, the customer notification step 210 might be performed after the product collection step 212.

At block 214, the identity of the requesting customer is determined. This determination may be made by some type and arrangement of sensors, such as, without limitation, an image capture device directed at the shelf or kiosk where the product request is made, an arrangement of audio sensors that triangulate a predetermined sound at the shelf or kiosk, or a Wi-Fi monitoring system in the shopping facility that determines the location of the customer's mobile device. At block 216, this sensor data may be used to monitor the location of the customer as the customer continues with his or her shopping experience within the store. In one form, image recognition software might be used, and in another form, an employee may identify the customer later (and the current location) from the sensor data. For example, in one form, an employee may view image(s) of the customer and, once the product has been collected, look for the customer from image capture devices arranged around the shopping facility. At block 218, in one form, when the product has been collected and is ready for delivery, the current location of the customer may be transmitted to an employee. At block 220, with this information, the employee can complete delivery of the requested merchandise to the customer.

Following from block 208, if the product is determined not to be present at the shopping facility, the process 200 may proceed to the left-hand side of FIG. 2. At block 222, the customer may be informed that the requested product is not available at the shopping facility. However, at block 224, a substitute product may be selected. This selection of a substitute product may be accomplished various ways, including, without limitation, selecting a substitute from other products in the same general category of the requested product (such as cereal), selecting a substitute based on the purchase history of the customer (such as may be determined from a customer database), and selecting a substitute based on the customers' preferences and values (such as by using the concept of value vectors, described in further detail below). Also, some combination of these approaches may be used. At block 226, once a substitute product has been selected, it is suggested to the customer as an alternative to the unavailable requested product.

At block 228, the customer may make a decision as to whether to accept the substitute product. If the customer decides to accept the substitute product, the process 200 may provide convenient in-store delivery of the product to the customer while the customer continues with his or her shopping. The process 200 may then proceed to the in-store delivery steps of blocks 210-220. If the customer decides not to accept the substitute product, the process 200 may proceed to block 230. At block 230, the options of home delivery or future pick-up at the shopping facility or some other shopping facility may be communicated to the customer. The customer's address may be available from a customer database, or the customer may input a delivery address or a time for future pick-up of the requested item.

In this manner, the customer is provided with several possibilities for taking steps for immediately fulfilling his request for a product. The shopping facility provides the following possibilities for completion of the request: (1) in-store delivery of the requested product; (2) in-store delivery of a substitute product; or (3) home delivery or future pick-up of the requested product at the same or a different shopping facility. By making these various options available to the customer, the shopping facility provides customer convenience and increases the likelihood that the customer will make a purchase. In contrast, if a product is not available (i.e., not on a shelf at the shopping facility) and these various options are not suggested, it becomes more likely that the customer will simply give up on the purchase.

In one form, as mentioned above, this disclosure makes use of the concept of “value vectors.” This disclosure generally seeks to match a substitute product (when a requested product is not available) with customer-specific values, affinities, aspirations, and preferences, which are measured in terms of “value vectors.” It is generally contemplated that there are multiple possible substitute products. This disclosure seeks to match possible substitute products with a specific customer's values, affinities, aspirations, and preferences. If this match can be made, an appealing substitute product will be suggested to the customer. As used herein, the term “customer” includes both customers who make an actual purchase and to potential customers who may or may not make a purchase. “Value vectors” are described in more detail as follows.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

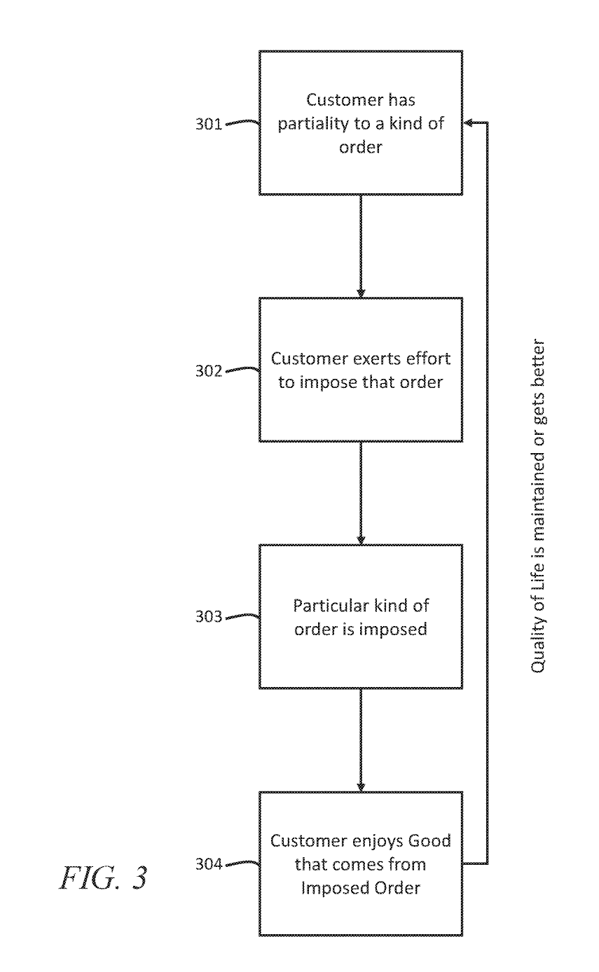

FIG. 3 provides a simple illustrative example in these regards. At block 301 it is understood that a particular person has a partiality (to a greater or lesser extent) to a particular kind of order. At block 302 that person willingly exerts effort to impose that order to thereby, at block 303, achieve an arrangement to which they are partial. And at block 304, this person appreciates the “good” that comes from successfully imposing the order to which they are partial, in effect establishing a positive feedback loop.

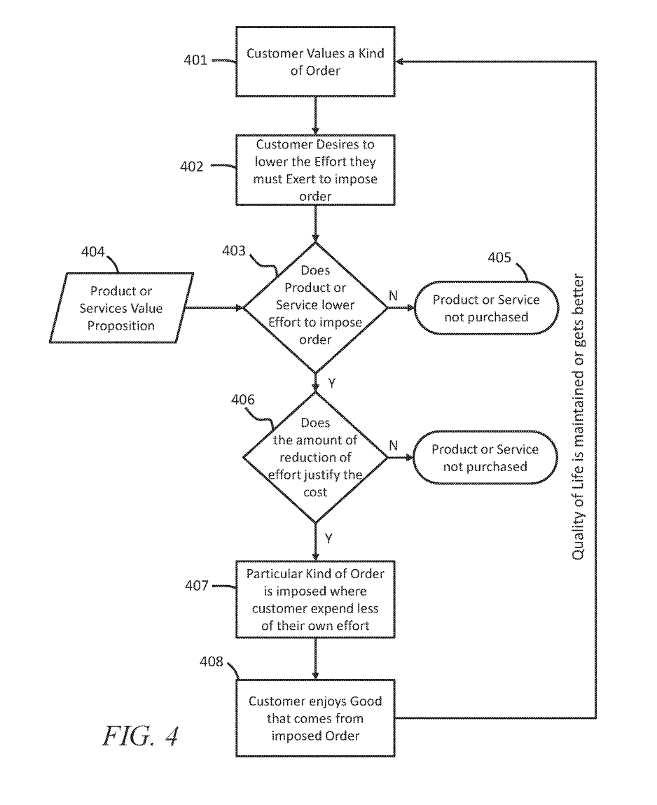

Understanding these partialities to particular kinds of order can be helpful to understanding how receptive a particular person may be to purchasing a given product or service. FIG. 4 provides a simple illustrative example in these regards. At block 401 it is understood that a particular person values a particular kind of order. At block 402 it is understood (or at least presumed) that this person wishes to lower the effort (or is at least receptive to lowering the effort) that they must personally exert to impose that order. At decision block 403 (and with access to information 404 regarding relevant products and or services) a determination can be made whether a particular product or service lowers the effort required by this person to impose the desired order. When such is not the case, it can be concluded that the person will not likely purchase such a product/service 405 (presuming better choices are available).

When the product or service does lower the effort required to impose the desired order, however, at block 406 a determination can be made as to whether the amount of the reduction of effort justifies the cost of purchasing and/or using the proffered product/service. If the cost does not justify the reduction of effort, it can again be concluded that the person will not likely purchase such a product/service 405. When the reduction of effort does justify the cost, however, this person may be presumed to want to purchase the product/service and thereby achieve the desired order (or at least an improvement with respect to that order) with less expenditure of their own personal effort (block 407) and thereby achieve, at block 408, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

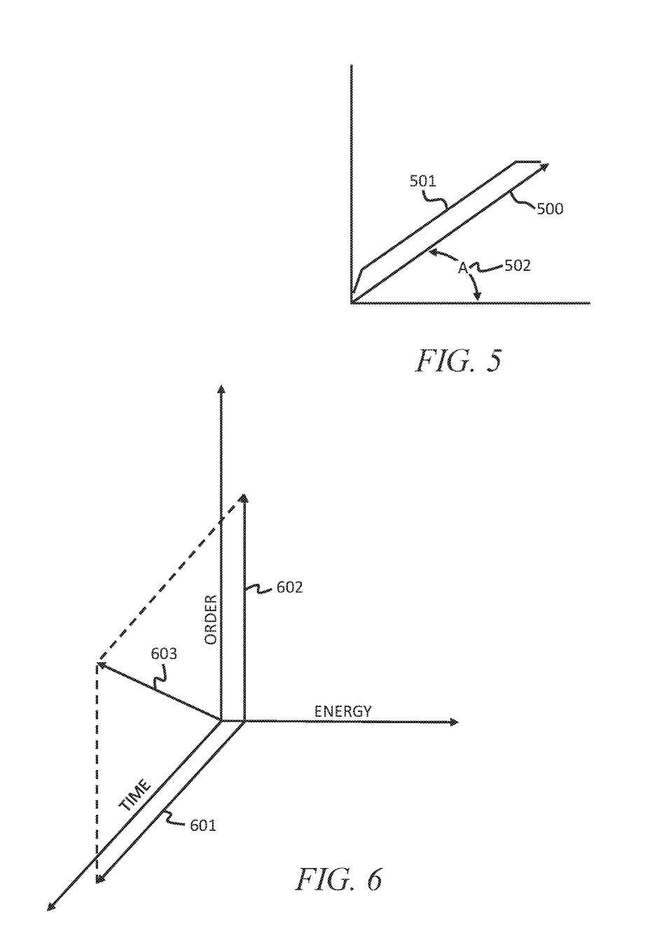

FIG. 5 provides some illustrative examples in these regards. By one approach the vector 500 has a corresponding magnitude 501 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 501, the greater the strength of that belief and vice versa. Per another example, the vector 500 has a corresponding angle A 502 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 6 presents a space graph that illustrates many of the foregoing points. A first vector 601 represents the time required to make such a wristwatch while a second vector 602 represents the order associated with such a device (in this case, that order essentially represents the skill of the craftsman). These two vectors 601 and 602 in turn sum to form a third vector 603 that constitutes a value vector for this wristwatch. This value vector 603, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

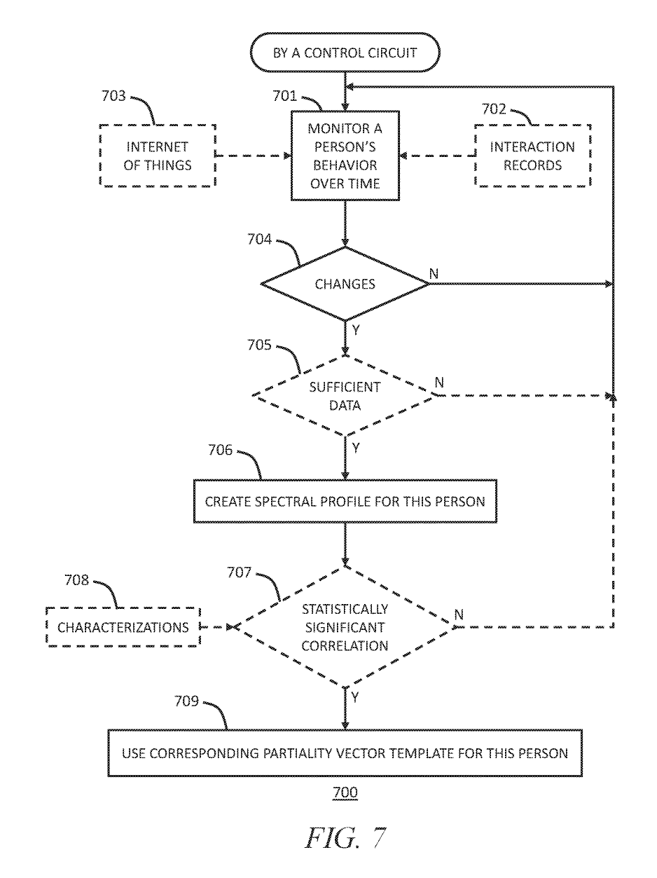

FIG. 7 presents a process 700 that illustrates yet another approach in these regards. For the sake of an illustrative example it will be presumed here that a control circuit of choice (with useful examples in these regards being presented further below) carries out one or more of the described steps/actions.

At block 701 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 702 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 702 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (TOT) 703. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 700 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 704 this process 700 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 705 this process 700 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

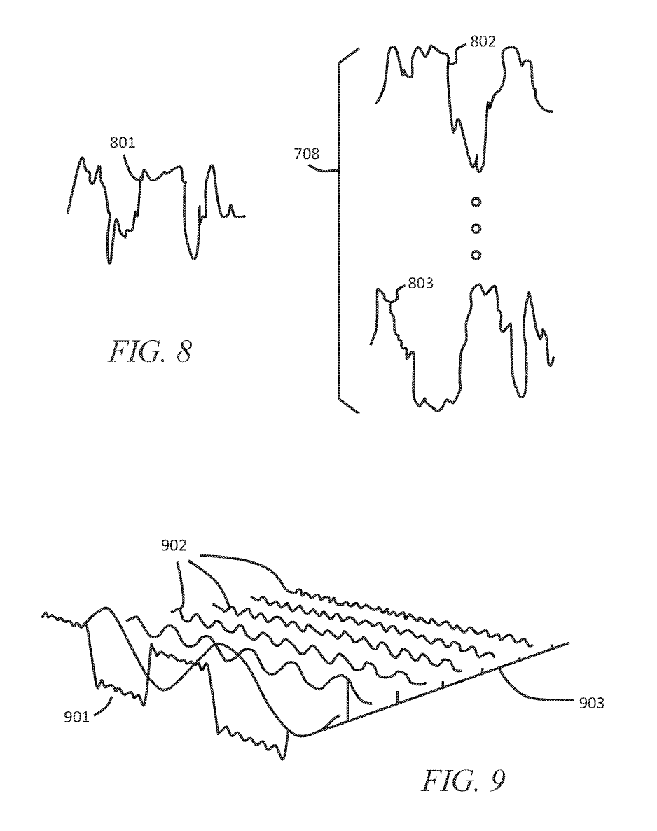

At block 707 this process 700 uses these detected changes to create a spectral profile for the monitored person. FIG. 8 provides an illustrative example in these regards with the spectral profile denoted by reference numeral 801. In this illustrative example the spectral profile 801 represents changes to the person's behavior over a given period of time (such as an hour, a day, a week, or some other temporal window of choice). Such a spectral profile can be as multidimensional as may suit the needs of a given application setting.

At optional block 707 this process 700 then provides for determining whether there is a statistically significant correlation between the aforementioned spectral profile and any of a plurality of like characterizations 708. The like characterizations 708 can comprise, for example, spectral profiles that represent an average of groupings of people who share many of the same (or all of the same) identified partialities. As a very simple illustrative example in these regards, a first such characterization 802 might represent a composite view of a first group of people who have three similar partialities but a dissimilar fourth partiality while another of the characterizations 803 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 9, by one approach the selected characterization (denoted by reference numeral 901 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 901 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 9 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 9) in the same sense as, for example, a radio or acoustic wave, it will nevertheless be understood that such a behavioral characterization 901 can itself be broken down into a plurality of sub-waves 902 that, when summed together, equal or at least approximate to some satisfactory degree the behavioral characterization 901 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

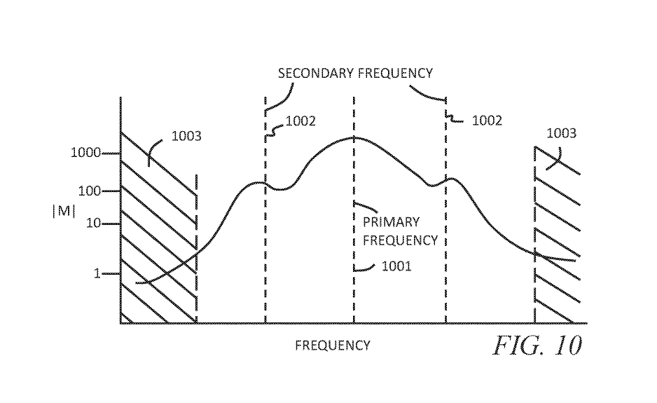

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 10, for many people the spectral profile of the individual person will exhibit a primary frequency 1001 for which the greatest response (perhaps many orders of magnitude greater than other evident frequencies) to life is exhibited and apparent. In addition, the spectral profile may also possibly identify one or more secondary frequencies 1002 above and/or below that primary frequency 1001. (It may be useful in many application settings to filter out more distant frequencies 1003 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 901, those partialities can be used as an initial template for a person whose own behaviors permit the selection of that particular characterization 901. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

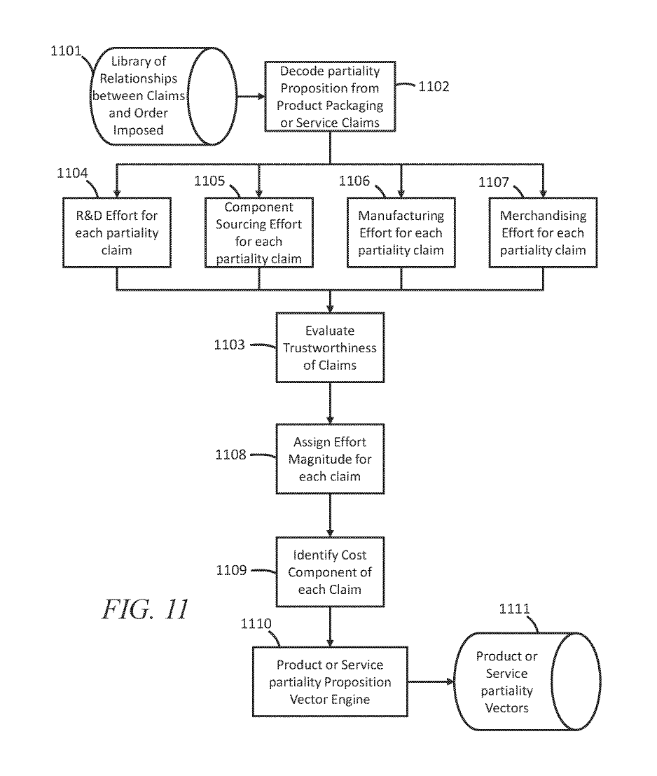

FIG. 11 presents one non-limiting illustrative example in these regards. The illustrated process presumes the availability of a library 1101 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 1102 this process provides for decoding one or more partiality propositions from specific product packaging (or service claims). For example, the particular textual/graphics-based claims presented on the packaging of a given product can be used to access the aforementioned library 1101 to identify one or more corresponding imposed orders from which one or more corresponding partialities can then be identified.

At block 1103 this process provides for evaluating the trustworthiness of the aforementioned claims. This evaluation can be based upon any one or more of a variety of data points as desired. FIG. 11 illustrates four significant possibilities in these regards. For example, at block 1104 an actual or estimated research and development effort can be quantified for each claim pertaining to a partiality. At block 1105 an actual or estimated component sourcing effort for the product in question can be quantified for each claim pertaining to a partiality. At block 1106 an actual or estimated manufacturing effort for the product in question can be quantified for each claim pertaining to a partiality. And at block 1107 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 1108 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 1109 this process provides for identifying a cost component of each claim, this cost component representing a monetary value. At block 1110 this process can use the foregoing information with a product/service partiality propositions vector engine to generate a library 1111 of one or more corresponding partiality vectors for the processed products/services. Such a library can then be used as described herein in conjunction with partiality vector information for various persons to identify, for example, products/services that are well aligned with the partialities of specific individuals.

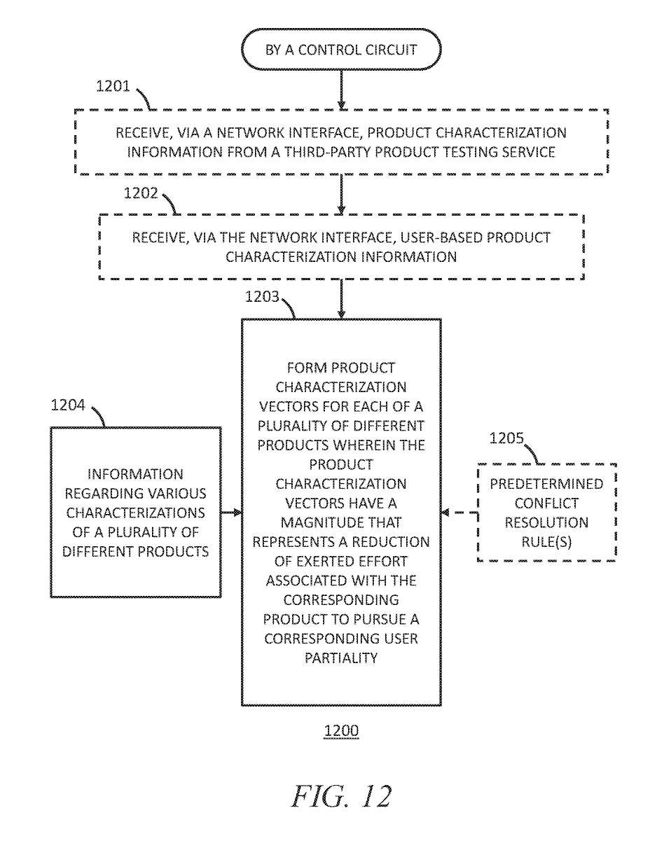

FIG. 12 provides another illustrative example in these same regards and may be employed in lieu of the foregoing or in total or partial combination therewith. Generally speaking, this process 1200 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 12, this process 1200 can be carried out by a control circuit of choice. Specific examples of control circuits are provided elsewhere herein.

As described further herein in detail, this process 1200 makes use of information regarding various characterizations of a plurality of different products. These teachings are highly flexible in practice and will accommodate a wide variety of possible information sources and types of information. By one optional approach, and as shown at optional block 1201, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself)

As another example, and as illustrated at optional block 1202, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1200 provides for accessing (see block 1204) information regarding various characterizations of each of a plurality of different products. This information 1204 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1204 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1203 the control circuit uses the foregoing information 1204 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1204. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1205 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1204 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

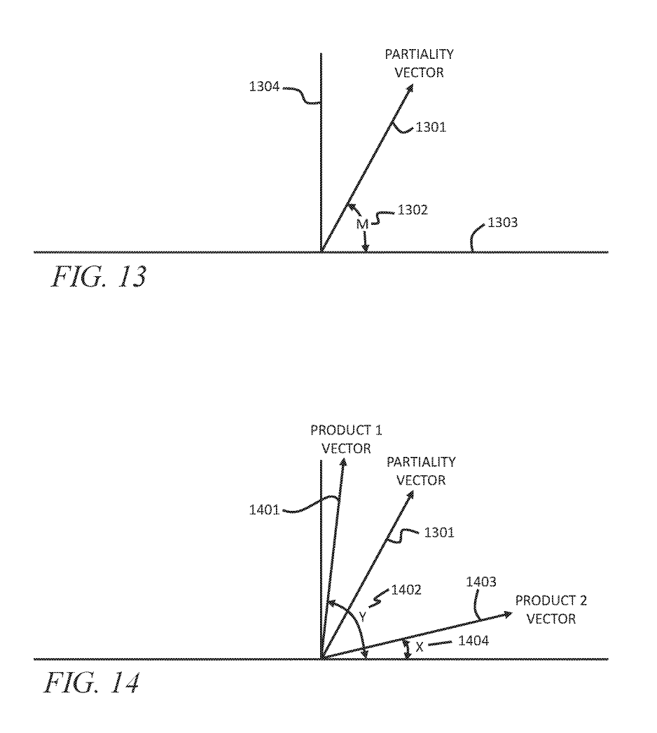

As noted above, the magnitude corresponding to a particular partiality vector for a particular person can be expressed by the angle of that partiality vector. FIG. 13 provides an illustrative example in these regards. In this example the partiality vector 1301 has an angle M 1302 (and where the range of available positive magnitudes range from a minimal magnitude represented by 0° (as denoted by reference numeral 1303) to a maximum magnitude represented by 90° (as denoted by reference numeral 1304)). Accordingly, the person to whom this partiality vector 1201 pertains has a relatively strong (but not absolute) belief in an amount of good that comes from an order associated with that partiality.

FIG. 14, in turn, presents that partiality vector 1301 in context with the product characterization vectors 1401 and 1403 for a first product and a second product, respectively. In this example the product characterization vector 1401 for the first product has an angle Y 1402 that is greater than the angle M 1302 for the aforementioned partiality vector 1301 by a relatively small amount while the product characterization vector 1403 for the second product has an angle X 1404 that is considerably smaller than the angle M 1302 for the partiality vector 1301.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1401 with the partiality vector 1301 will be larger than the resultant scaler value for the vector dot product of the product 2 vector 1403 with the partiality vector 1301. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·Plv) might equal (1, 1), hence yielding a scalar result of ∥1∥ (where Cv refers to the corresponding partiality vector for this person and Plv represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1, 0), hence yielding a scalar result of ∥1/2∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥1/2∥), but the dot product for the $10/week organic apples may now drop (for example, to ∥1/2∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

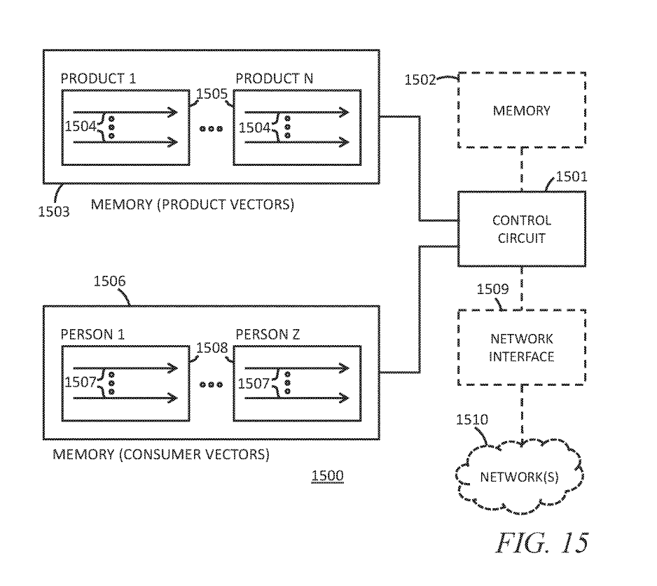

FIG. 15 presents an illustrative apparatus 1500 for conducting, containing, and utilizing the foregoing content and capabilities. In this particular example, the enabling apparatus 1500 includes a control circuit 1501. Being a “circuit,” the control circuit 1501 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1501 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1501 is configured (for example, by using corresponding programming as will be well understood by those skilled in the art) to carry out one or more of the steps, actions, and/or functions described herein.

By one optional approach the control circuit 1501 operably couples to a memory 1502. This memory 1502 may be integral to the control circuit 1501 or can be physically discrete (in whole or in part) from the control circuit 1501 as desired. This memory 1502 can also be local with respect to the control circuit 1501 (where, for example, both share a common circuit board, chassis, power supply, and/or housing) or can be partially or wholly remote with respect to the control circuit 1501 (where, for example, the memory 1502 is physically located in another facility, metropolitan area, or even country as compared to the control circuit 1501).

This memory 1502 can serve, for example, to non-transitorily store the computer instructions that, when executed by the control circuit 1501, cause the control circuit 1501 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1502 or, as illustrated, in a separate memory 1503 are the vectorized characterizations 1504 for each of a plurality of products 1505 (represented here by a first product through an Nth product where “N” is an integer greater than “1”). In addition, and again either stored in this memory 1502 or, as illustrated, in a separate memory 1506 are the vectorized characterizations 1507 for each of a plurality of individual persons 1508 (represented here by a first person through a Zth person wherein “Z” is also an integer greater than “1”).

In this example the control circuit 1501 also operably couples to a network interface 1509. So configured the control circuit 1501 can communicate with other elements (both within the apparatus 1500 and external thereto) via the network interface 1509. Network interfaces, including both wireless and non-wireless platforms, are well understood in the art and require no particular elaboration here. This network interface 1509 can compatibly communicate via whatever network or networks 1510 may be appropriate to suit the particular needs of a given application setting. Both communication networks and network interfaces are well understood areas of prior art endeavor and therefore no further elaboration will be provided here in those regards for the sake of brevity.

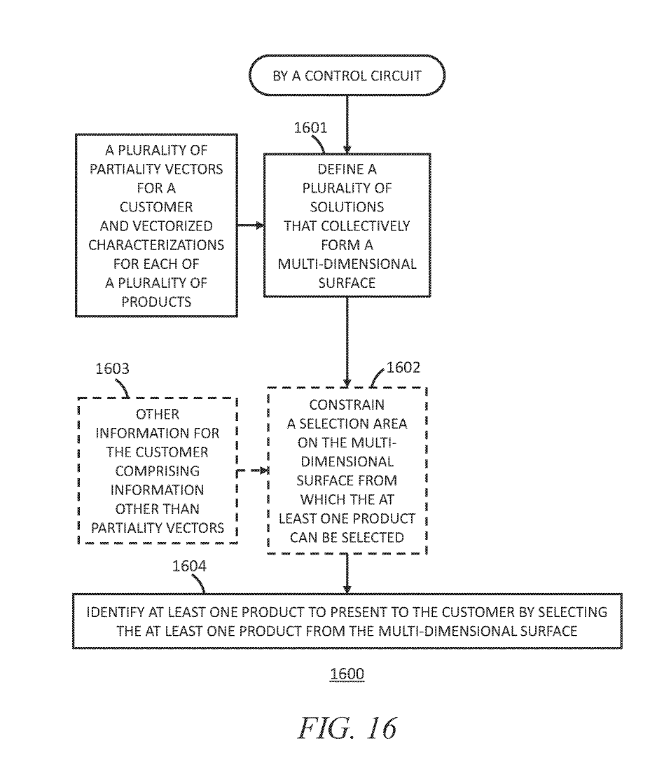

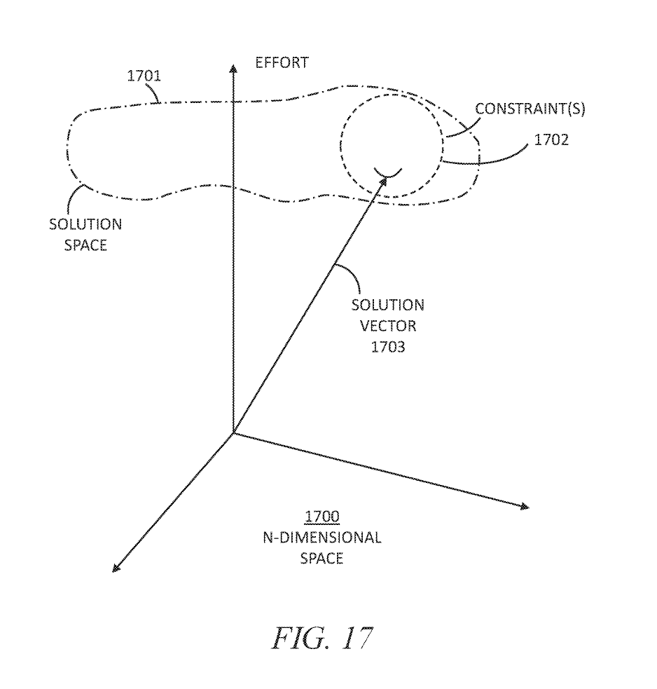

By one approach, and referring now to FIG. 16, the control circuit 1501 is configured to use the aforementioned partiality vectors 1507 and the vectorized product characterizations 1504 to define a plurality of solutions that collectively form a multidimensional surface (per block 1601). FIG. 17 provides an illustrative example in these regards. FIG. 17 represents an N-dimensional space 1700 and where the aforementioned information for a particular customer yielded a multi-dimensional surface denoted by reference numeral 1701. (The relevant value space is an N-dimensional space where the belief in the value of a particular ordering of one's life only acts on value propositions in that space as a function of a least-effort functional relationship.)

Generally speaking, this surface 1701 represents all possible solutions based upon the foregoing information. Accordingly, in a typical application setting this surface 1701 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 16 and 17, at optional block 1602 the control circuit 1501 can be configured to use information for the customer 1603 (other than the aforementioned partiality vectors 1507) to constrain a selection area 1702 on the multi-dimensional surface 1701 from which at least one product can be selected for this particular customer. By one approach, for example, the constraints can be selected such that the resultant selection area 1702 represents the best 95th percentile of the solution space. Other target sizes for the selection area 1702 are of course possible and may be useful in a given application setting.

The aforementioned other information 1603 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1702), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1604 the control circuit 1501 can then identify at least one product to present to the customer by selecting that product from the multi-dimensional surface 1701. In the example of FIG. 17, where constraints have been used to define a reduced selection area 1702, the control circuit 1501 is constrained to select that product from within that selection area 1702. For example, and in accordance with the description provided herein, the control circuit 1501 can select that product via solution vector 1703 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1501 may respond per these teachings to learning that the customer is planning a party that will include seven other invited individuals. The control circuit 1501 may therefore be looking to identify one or more particular beverages to present to the customer for consideration in those regards. The aforementioned partiality vectors 1507 and vectorized product characterizations 1504 can serve to define a corresponding multi-dimensional surface 1701 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1702 to beverages that contain no alcohol. As another example in these regards, the control circuit 1501 may have objective information that the party is to be held in a state park that prohibits alcohol and may therefore similarly constrain the available selection area 1702 to beverages that contain no alcohol.

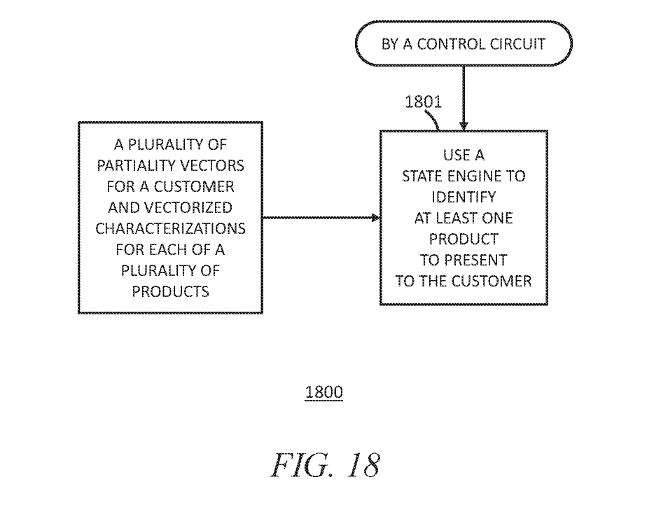

As described above, the aforementioned control circuit 1501 can utilize information including a plurality of partiality vectors for a particular customer along with vectorized product characterizations for each of a plurality of products to identify at least one product to present to a customer. By one approach 1800, and referring to FIG. 18, the control circuit 1501 can be configured as (or to use) a state engine to identify such a product (as indicated at block 1801). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

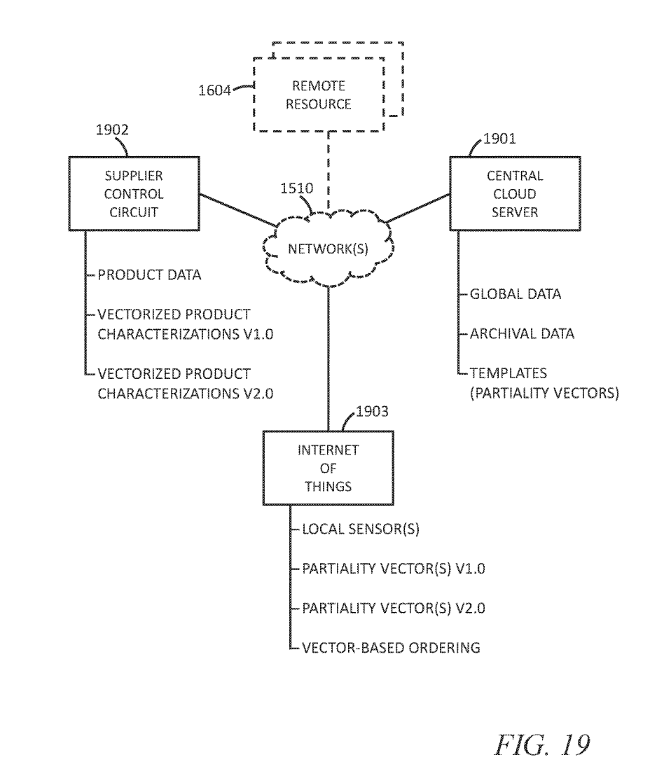

It will be appreciated that the apparatus 1500 described above can be viewed as a literal physical architecture or, if desired, as a logical construct. For example, these teachings can be enabled and operated in a highly centralized manner (as might be suggested when viewing that apparatus 1500 as a physical construct) or, conversely, can be enabled and operated in a highly decentralized manner. FIG. 19 provides an example as regards the latter.

In this illustrative example a central cloud server 1901, a supplier control circuit 1902, and the aforementioned Internet of Things 1903 communicate via the aforementioned network 1510.

The central cloud server 1901 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1901 that store identical, overlapping, or wholly distinct content.)

The supplier control circuit 1902 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 19 by the expression “vectorized product characterizations V1.0”) for a given product as well as subsequent, updated vectorized product characterizations (denoted in FIG. 19 by the expression “vectorized product characterizations V2.0”) for the same product. Such modifications may have been made by the supplier control circuit 1902 itself or may have been made in conjunction with or wholly by an external resource as desired.

The Internet of Things 1903 can comprise any of a variety of devices and components that may include local sensors that can provide information regarding a corresponding user's circumstances, behaviors, and reactions back to, for example, the aforementioned central cloud server 1901 and the supplier control circuit 1902 to facilitate the development of corresponding partiality vectors for that corresponding user. Again, however, these teachings will also support a decentralized approach. In many cases devices that are fairly considered to be members of the Internet of Things 1903 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1902 and use that information in conjunction with local partiality vector information to facilitate the vector-based ordering.

Also, if desired, the smart phone in this example can itself modify and update partiality vectors for the corresponding user. To illustrate this idea in FIG. 19, this device can utilize, for example, information gained at least in part from local sensors to update a locally-stored partiality vector (represented in FIG. 19 by the expression “partiality vector V1.0”) to obtain an updated locally-stored partiality vector (represented in FIG. 19 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1904. These remote resources 1904 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

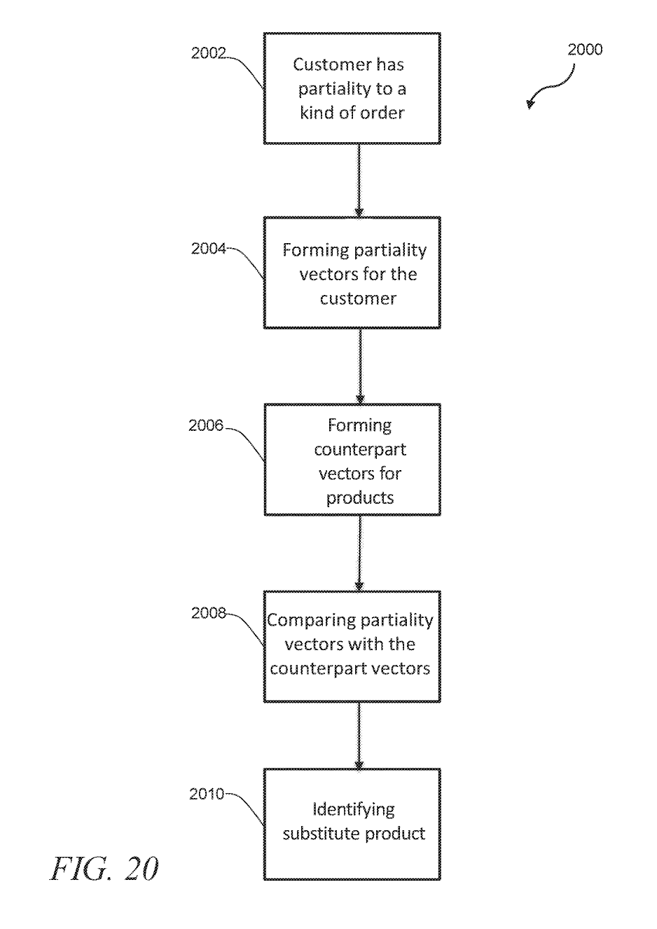

So, applying this value vector approach, a substitute product may be selected based on customer values, affinities, aspirations, and preferences. Referring to FIG. 20, there is shown a process 2000 (following up on the value vector approach described above) that illustrates selection of the substitute product based on a value vector approach. At block 2002, it is shown that the customer has a partiality to a certain kind of order. At block 2004, this partiality information may be accessed and user to form corresponding partiality vectors for the customer wherein the partiality vector has a magnitude that corresponds to a magnitude of the customer's belief in an amount of good that comes from an order associated with that partiality. At block 2006, counterpart product vectors (representing potential substitute products) can be formed wherein the counterpart vectors have a magnitude that represents the degree to which each of the products pursues a corresponding partiality. At block 2008, the partiality vectors for the customer and the products vectors may be used and compared to identify products that accord with a given customer's own partialities. At block 2010, a substitute product has been identified that accords with the given customer's own partialities. This process 2000 may be incorporated into system 100 and process 200 described above.

Although the concept of value vectors has been described with respect to matching substitute product vectors to customer value vectors, it is also contemplated that the substitute product vectors may be matched to vectors corresponding to the requested product. In other words, vectors may be created for a number of products, and these product vectors may be compared to the vectors of the requested product to determine a match. It is contemplated that the product requested by the customer will likely include vectors that correspond to the customer's partialities. So, instead of directly comparing potential substitute product vectors to customer partiality vectors, the potential substitute product vectors may be compared to vectors of the product actually requested by the customer (which may be assumed to reflect the customer's partialities). In this way, the potential substitute product vectors may be indirectly matched to the customer's partialities.

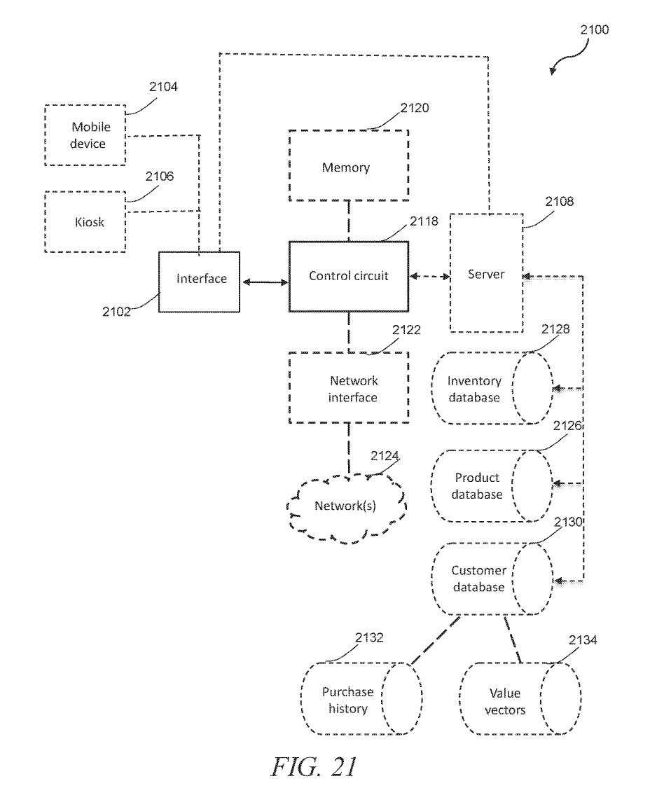

Referring to FIG. 21, there is shown another system 2100 for delivering products to customers in shopping facilities, but this system 2100 involves delivery to a customer at a customer-specified rendezvous within the shopping facility. This system 2100 is generally similar to system 100 and so does not require significant elaboration. However, unlike system 100, system 2100 does not require a sensor 110 because the customer identifies (or may be prompted to identify) a specific location within the shopping facility for pick-up of the requested item.

The system 2100 includes an electronic interface 2102 configured to receive a customer's request for a product at a shopping facility. As described above, in some forms, the electronic interface 2102 may include a kiosk 2106, a mobile device 2104, or a shopping facility server 2108. The electronic interface 2102 is communicatively coupled to a control circuit 2118 (which may, in turn, be coupled to or include a memory 2120 and a network interface 2122 coupled to a network 2124). The control circuit 2118 may be operatively coupled to a server 2108, which may enable access to various databases, such as: a product database 2126, an inventory database 2128, a customer database 2130, a purchase history sub-database 2132, or a value vectors sub-database 2134. In this manner, the control circuit 2110 may be configured to: identify the product requested by the customer (such as by accessing the product database 2126); initiate a determination if the product is present at the shopping facility (such as by accessing the inventory database 2128); if the product is present, provide an instruction to collect the product (such as by creating an action or task for an employee and/or communicating with the employee); receive a communication from the customer identifying a rendezvous location in the shopping facility (such as via the electronic interface 2102); and instruct delivery of the collected product to the customer at the rendezvous location (such as by creating an action/task and communicating with an employee).

As can be seen, in this system 2100, the customer communicates an in-store location, so the system 2100 does not require monitoring by a sensor. In one form, the customer may be prompted to provide this in-store rendezvous location. Where the requested product is not available, a substitute product may be suggested. This substitute product may be suggested based on another product type within that category of products (which may be determined by accessing the product database 2126) or based on customer information from a customer database 2130. This customer information may include purchase history data (such as from a purchase history sub-database 2132) or base on value vectors partiality data (such as from a value vectors sub-database 2134).

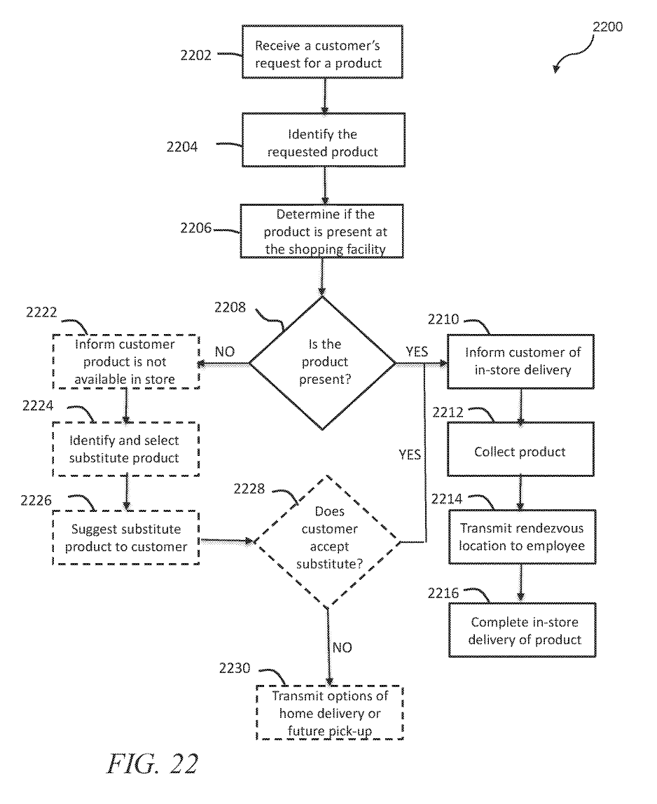

Similarly, referring to FIG. 22, there is shown a process 2200 for delivering a requested product to a customer at a customer-specified rendezvous within the shopping facility. Again, this process 2200 is generally similar to process 200 and so does not require significant discussion. However, unlike process 200, process 2200 does not require identifying and monitoring a customer because the customer identifies (or may be prompted to identify) a specific rendezvous area within the shopping facility for pick-up of the requested item.

At block 2202, the process 2200 involves receiving a customer's request for a product (such as via an electronic interface). At block, 2204, the requested product is identified, and at block 2206, it is determined if the product is present at the shopping facility. For example, in one form, a control circuit may access a product database to identify the product corresponding to a specific product identifier (barcode), and the control circuit may then access an inventory database to determine if the product is available at the shopping facility.

Blocks 2208-2216 show steps of the process 2200 when the requested product is determined to be present at the shopping facility (step 2208). At block 2210, the customer may be informed that the product is available and that the product will be delivered in the shopping facility. At block 2212, an employee may collect the product, and at block 2214, the rendezvous location specified by the customer may be transmitted to the employee. At block 2216, the employee may complete the in-store delivery by presenting the product to the customer at the rendezvous location.

Blocks 2222-2230 show steps of the process 2200 when the requested product is determined not to be available at the shopping facility (step 2208). At block 2222, the customer may be informed that the product is not available at the shopping facility, but at blocks 2224 and 2226, a substitute product may be identified and selected and suggested to the customer. The selection of the substitute product may be accomplished in various ways, such as by, without limitation, selecting another product in the same category as the requested product, selecting another product on the basis of the customer's purchase history, or selecting a product based on the value vectors of the customer (or by some combination of these approaches). If the customer accepts the suggestion of the substitute product (step 2228), the process 2200 may then proceed to in-store delivery of the substitute product at the rendezvous location (blocks 2210-2216). Alternatively, if the customer does not accept the suggestion of the substitute product, the customer may be informed and select the options of home delivery or future pick-up at the shopping facility or at another shopping facility (step 2230).

In another form that may use partiality vectors and vectorized characterizations, pursuant to various embodiments, systems, apparatuses and methods are provided herein useful to providing a customized retail shopping experience. In some embodiments, a system includes a central control system and a plurality of active shutter glasses systems (SGS) that can temporarily or permanently be associated with a particular customer. The SGSs are configured to be used at a retail shopping facility to enable the corresponding customer to see displayed products and/or product information that is intended for that customer. Each of the SGSs includes controllable lenses and is configured to selectively control rates of when one or both of the lenses are opaque and/or when a person can see through one or both of the lenses. The central control system is in wireless communication with each of the SGSs. Further, the central control system can identify a frame profile at which a first SGS is to make visible a first product content intended for a first customer. In some instances, the central control system similarly can identify a different frame profile at which each of one or more other SGSs are to make visible different product content intended for one or more different customers. The central control system can identify a location of the first SGS while within the shopping facility, and can direct the first product content to be displayed on one or more displays located relative to the location and at the first frame profile such that the first product content is visible through the first SGS to the first customer, and while not being visible to one or more of the other customers through corresponding other SGSs.

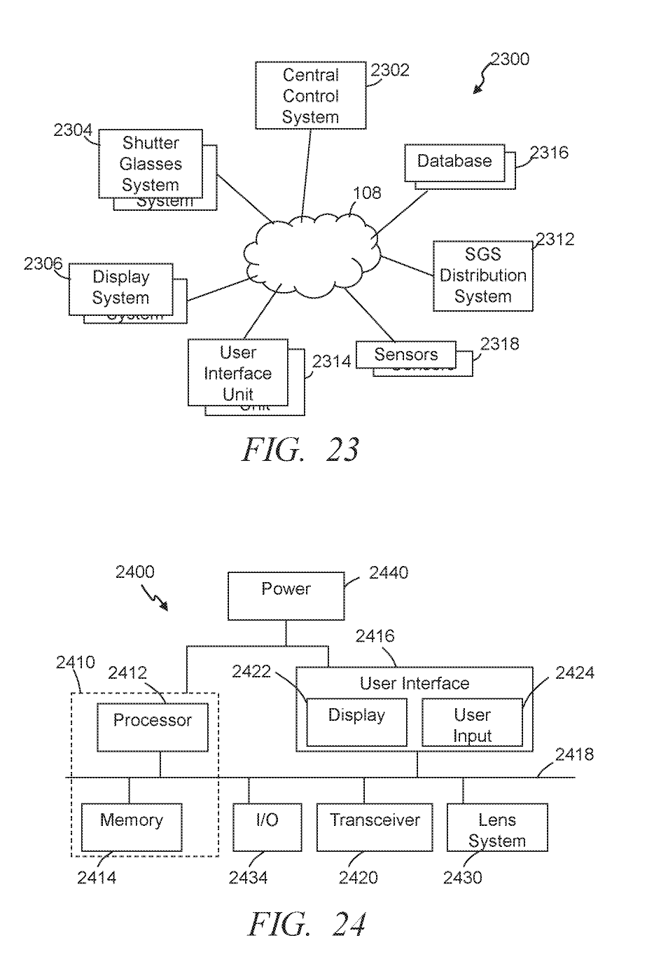

FIG. 23 illustrates a simplified block diagram of an exemplary retail customization system 2300 that provides customized virtual retail shopping experiences to multiple customers at one or more shopping facilities, in accordance with some embodiments. The system includes one or more central control systems 2302 in communication with multiple shutter glasses systems (SGS) 2304 and multiple display systems 2306 over a distributed computer and/or communication network 2308. In some implementations, the system further includes one or more SGS distribution systems 2312. In some embodiments, the system includes customers' and/or workers' user interface units 2314. Some embodiments include one or more sensors 2318 and/or sensor systems. The sensors can include substantially any relevant sensor, such as distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, motion sensors, RFID readers, cameras, image processing systems, other such sensors or combination of two or more of such sensors. The sensors can be positioned at various locations in the shopping facility. In some embodiments, the user interface units can provide sensor information and be considered part of the sensor system(s). The user interface units can be one or more of a variety of user interface units including, but not limited to, mobile and/or handheld electronic devices such as so-called smart phones and portable computers such as tablet/pad-styled computers, custom shopping facility units (e.g., scanners, two-way communication devices, etc.), and other such devices. The shopping facility may be any size of format facility, and may include products from one or more merchants. For example, a facility may be a single store operated by one merchant or may be a collection of stores covering multiple merchants such as a mall.

The central control system 2302 controls the operation of the multiple SGSs 2304. In some implementations, the SGSs are configured to selectively control rates of when one or both of the lenses are opaque or affect a person's ability to see through the lens or lenses, and when a person can see through one or both of the lenses (e.g., when one or more both of the lenses are transparent). The central control system can, in part, cause instructions, rates and/or code to be communicated to individual SGSs regarding frame profiles used by the respective SGSs to control when one or both of the lenses are to be transparent and/or enable a customer (or other user) to see through the lens or lenses.

The display systems include displays that are placed at locations in the shopping facility that are accessible to customers. In some instances, multiple displays are positioned adjacent to each other and can cooperatively display product content across multiple displays. For example, in some instances, one or more display systems are positioned along at least part of an aisle. Product content can be displayed through the display systems so that as a customer views the product content the display depicts an aisle full of different products that are for sale through the shopping facility. Further, in some embodiments the product content is displayed to appear as three-dimensional to the customer. In some embodiments, the display systems further include display control circuits that can control frame profiles at which one or more sources of product content are displayed. Additionally or alternatively, one or more product contents are supplied, by one or more content supply systems, to a display system at desired display frame profiles, and the display system displays the frames as received from the content supply system consistent with the desired display frame profiles. Some embodiments may further provide frame profile information to be used by the one or more display systems and/or the content sources to control the frame profiles at which one or more product content and/or other content is displayed. The frame profile information may be specific to a single content, or may have frame profiles for different content. Further, the frame profile information may specify multiple different frame profiles for a single content and timing regarding when to apply the multiple different frame profiles. In other instances, updated frame profile information may be communicated identifying a change in frame profile of one or more contents, and in some instances timing information regarding when to apply the changed frame profiles. Some embodiments may specify frame profile modulation information defining changes in frame profiles and the modulation rate or timing at which the frame profile is to be modulated.

Some embodiments include one or more SGS distribution systems 2312 that is configured to associate customers with SGSs in use within the shopping facility. For example, in some embodiments, the SGSs will be issued to customers for use while in the shopping facility, and typically temporarily issued to customers. The SGS distribution system can obtain customer identifying information (e.g., a customer name, a customer number, a customer credit card number, finger print, eye and/or retinal image, other such information or combination of such information) and associate an SGS identifier of an SGS issued to that customer (or a person associated with that customer, such as a child, spouse, guest, etc.) and associate the SGS identifier with the customer based on the customer identifying information. In some applications, the SGS dispensing system may be operated in part with a shopping facility worker (e.g., worker hands out the SGSs to customers, and may direct the acquisition of the SGS identifier, such as through scanning a bar code, moving the SGS proximate an RFID reader, manually entering in an SGS identifier through a user interface of the SGS distribution system or other device in communication with the SGS distribution system or central controller), the SGS dispensing system may be a kiosk or vending machine type system that allows customers to present identifying information (e.g., detect a customer card, read a credit card, detect an RFID tag carried by the customer, receive a communication from a customer's user interface unit, etc.) and dispense one or more SGSs (e.g., in response to confirming a customer's identifying information), the SGS dispensing system may be implemented through other such applications. In some embodiments, the SGS dispensing system may additionally or alternatively detect a customer owned SGS as the customer enters the store or travels through the store (e.g., based on an RFID tag of the SGS) and obtain customer identifier information through a customer database and/or through other methods.

In some embodiments, the system includes and/or communicates with one or more user interface units 2314 that are associated with customers and/or workers of the shopping facilities. The user interface units can be one or more of a variety of user interface units including, but not limited to, mobile and/or handheld electronic devices such as so-called smart phones and portable computers such as tablet/pad-styled computers, custom shopping facility units (e.g., scanners, two-way communication devices, etc.), and other such devices. Some or all of the user interface units may wirelessly communicate with the central control system over one or more of the computer and/or communication networks 2308 (e.g., Wi-Fi wireless network, cellular, Bluetooth, Ethernet, etc.).

Further, the circuits, circuitry, systems, devices, processes, methods, techniques, functionality, services, servers, sources and the like described herein may be utilized, implemented and/or run on many different types of devices and/or systems. FIG. 24 illustrates an exemplary system 2400 that may be used for implementing any of the components, circuits, circuitry, systems, functionality, apparatuses, processes, or devices of the system 2300, and/or other above or below mentioned systems or devices, or parts of such circuits, circuitry, functionality, systems, apparatuses, processes, or devices. For example, the system 2400 may be used to implement some or all of the central control system 2302, shutter glasses systems 2304, controllable lenses and/or lens control sub-systems, the display systems 2306, the SGS distribution systems 2312, the user interface units 2314, the databases 2316 and/or systems implementing the databases, and/or other such components, circuitry, functionality and/or devices. The databases can include one or more customer databases that store information corresponding to multiple different customers, one or more product databases that store information about products (e.g., information about products, pricing information, product value vectors, images, scans, three-dimensional representations, etc.), one or more content database identifying where to access and/or storing the product content and/or other content, inventory database identifying inventory information (e.g., listings of available inventory, location information, pricing, etc.), other such databases, or combinations of two or more of such databases. However, the use of the system 2400 or any portion thereof is certainly not required.

By way of example, the system 2400 may comprise a control circuit or processor module 2412, memory 2414, and one or more communication links, paths, buses or the like 2418. Some embodiments may include one or more user interfaces 2416, and/or one or more internal and/or external power sources or supplies 2440. The control circuit 2412 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 2412 can be part of control circuitry and/or a control system 2410, which may be implemented through one or more processors with access to one or more memory 2414 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 2400 may be used to implement one or more of the above or below, or parts of, components, circuits, systems, processes and the like. For example, the system may implement the central control system with the control circuit being a central control circuit, an SGS with an SGS control circuit, a display system with a display control circuit, an SGS distribution system with a distribution control circuit, or other components.

The user interface 2416 can allow a user to interact with the system 2400 and receive information through the system. In some instances, the user interface 2416 includes a display 2422 and/or one or more user inputs 2424, such as buttons, touch screen, track ball, keyboard, mouse, etc., which can be part of or wired or wirelessly coupled with the system 2400. Typically, the system 2400 further includes one or more communication interfaces, ports, transceivers 2420 and the like allowing the system 2400 to communicate over a communication bus, a distributed computer and/or communication network 2308 (e.g., a local area network (LAN), the Internet, wide area network (WAN), etc.), communication link 2418, other networks or communication channels with other devices and/or other such communications or combination of two or more of such communication methods. Further the transceiver 2420 can be configured for wired, wireless, optical, fiber optical cable, satellite, or other such communication configurations or combinations of two or more of such communications. Some embodiments include one or more input/output (I/O) ports 2434 that allow one or more devices to couple with the system 2400. The I/O ports can be substantially any relevant port or combinations of ports, such as but not limited to USB, Ethernet, or other such ports. The I/O interface 2434 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The system 2400 comprises an example of a control and/or processor-based system with the control circuit 2412. Again, the control circuit 2412 can be implemented through one or more processors, controllers, central processing units, logic, software and the like. Further, in some implementations the control circuit 2412 may provide multiprocessor functionality.

The memory 2414, which can be accessed by the control circuit 2412, typically includes one or more processor readable and/or computer readable media accessed by at least the control circuit 2412, and can include volatile and/or nonvolatile media, such as RAM, ROM, EEPROM, flash memory and/or other memory technology. Further, the memory 2414 is shown as internal to the control system 2410; however, the memory 2414 can be internal, external or a combination of internal and external memory. Similarly, some or all of the memory 2414 can be internal, external or a combination of internal and external memory of the control circuit 2412. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 2308. The memory 2414 can store code, software, executables, scripts, data, content, lists, programming, programs, log or history data, user information, customer information, product information, and the like. While FIG. 24 illustrates the various components being coupled together via a bus, it is understood that the various components may actually be coupled to the control circuit and/or one or more other components directly.

Further, in some embodiments where the system 2400 implements some or all of the SGSs 2304, the system can include lens systems 2430, which can include controllable lenses and/or lens control circuits. The lens systems can control when one or both lenses can be seen through and when a user cannot see through the lenses.

In some embodiments, the customization system 2300 provides different customized retail shopping experiences for different customers. Further, in at least some instances, the system can simultaneously provide different customization experiences for different customers. The system utilizes the plurality of active SGSs 2304 that each comprising controllable lenses. Accordingly, each of the SGSs is configured to selectively control rates of when one or both of the lenses can be seen through (e.g., are transparent, tinted, partially transparent, etc.) and when one or both lenses inhibits or prevents a user from seeing through at least part of the lens or lenses. For example, in some applications the SGSs control when one or both of the lenses are opaque and when one or both of the lenses are transparent.

The central control system is associated with at least one retail shopping facility. In some implementations, the central control system is implemented at the shopping facility, while in other embodiments part or all of the central control system may be implemented remote from the shopping facility. Further, the central control system is separate from the SGSs, and is configured to be in wireless communication with each of the plurality of SGSs at least while the SGSs are within one or more areas within the shopping facility and/or within a threshold distance of an interior of the shopping facility. For example, the shopping facility may have limited areas where the SGSs are effective because of limited placement of display systems, while in other implementations, large areas or all of the sales floor of a shopping facility may include display systems. In some embodiments, the wireless communication is implemented with a limited effective communication range, such as through Wi-Fi, Bluetooth, Bluetooth low energy, ZigBee, radio frequency, other such wireless communication methods, or combination of two or more of such methods.

The central control system can control what content is made visible to different customers by controlling frame profiles of different content, and coordinating the control of the lenses of corresponding SGSs. In some embodiments, the central control system identifies different frame profiles at which different SGSs are to make visible different product content intended for different customers while at the shopping facility. For example, the central control system can identify a first frame profile at which a first SGS is to make visible a first product content intended to be viewed by a first customer, and identify a different second frame profile at which a second SGS is to make visible a second product content intended to be viewed by a second customer. As introduced above, the frame profiles may be constant for one or more SGSs, may vary over time for one or more SGSs, may be modulated, or the like.

In some embodiments, for example, a first SGS can be configured to operate at a first frame profile at which the first SGS is to make a first content, intended for a first customer, visible to the first customer, and a second SGS can be configured to operate at a different second frame profile at which the second SGS is to make a second content, intended for a second customer, visible to the second customer. When controlled based on the frame profiles, the first SGS based on the first frame profile enables the first customer to view the first content while preventing the first customer from seeing the second content, and the second SGS based on the second frame profile enables the second customer to view the second content while preventing the second customer from seeing the first content. Similarly, other content may be visible on the same display as the first and second content but at a different frame profile. For example, with four users a single display can control frames of four different content to be sequentially displayed at 60 frames per second with a display providing 240 Hz screen rate; a similar display can enable frames of six different content to be rendered at 40 frames per second allowing six different users to view the different content with the lenses SGSs controlled at substantially the same rate; and a similar display can enable frames of eight different content to be rendered at 30 frames per second allowing eight different users to view the different content with the lenses SGSs controlled at substantially the same rate. In other implementations, additional content may be displayed on one or more displays that may be visible to more than one use and/or customers that are not using SGSs. For example, some embodiments may direct two different contents intended for two different customers at a frame rate of 60 frames per second while one or more frames of a third content is displayed over 120 frames per second with the display having a 240 Hz screen rate. Other frame profiles can be used. When fewer users are viewing a display, other content, a white screen, a black screen, a pre-programmed message or other content can be displayed. This implementation may make the other content visible to customers with or without SGSs.

As another example, with a display having a 240 Hz screen rate, the frame profiles for two contents to be displayed in 3-D can be defined in some instances with at 60 frames per second (e.g., 60 FPS content 1 left eye, 60 FPS content 2 left eye, 60 FPS content 1 right eye, 60 FPS content 2 right eye); three contents displayed at 40 frames per second (e.g., 40 FPS content 1 left eye, 40 FPS content 2 left eye, 40 FPS content 3 left eye, 40 FPS content 1 right eye, 40 FPS content 2 right eye, 40 FPS content 3 right eye); four contents displayed at 30 frames per second (e.g., 30 FPS content 1 left eye, 30 FPS content 2 left eye, 30 FPS content 3 left eye, 30 FPS content 4 left eye, 30 FPS content 1 right eye, 30 FPS content 2 right eye, 30 FPS content 3 right eye, 30 FPS content 4 right eye). Additionally or alternatively, some embodiments modify and/or modulate the frame profiles and/or rates at which frames are displayed and that one or more lenses of one or more SGSs are controlled.

The location of the SGSs can be identified while within the shopping facility and/or while within a threshold distance of the shopping facility. The location can be determined based on sensing the SGSs (e.g., RFID, image processing, etc.), determining a location based on communications from the SGSs, receiving communications from the SGSs, detecting optical signals generated from the SGSs, receiving sensor data from SGSs (e.g., inertial sensor data, motion sensor data, wireless signal information, etc.), tracking movement of a customer associated with the SGS (e.g., RFID, image processing, facial and/or body recognition, communication from a user interface unit associated with the customer, etc.). Further, some embodiments can identify and/or determine a direction or orientation of the SGSs and/or the lenses of the SGSs (e.g., based on sensor data from the SGSs, image processing, detecting optical signal from the SGSs, etc.). Using the location and/or orientation information, the central control system can identify one or more display systems 2306 that are within a threshold distance of a particular SGSs, within a threshold angle relative to an orientation of the SGS, within a threshold predicted or potential movement of the SGSs, and/or other such considerations. The predicated movement can be based on a customer's movement patterns through the shopping facility during a current visit to the shopping facility, customers historic movements through shopping facilities, shopping list information available to the central control system (e.g., based on customer profile information), predicted purchases (e.g., based on historic purchases of a specific customer or one or more groups of customers, advertisements presented to the customer, value vectors of one or more customers, other such information, and often a combination of two or more of such information), other such information or combination of two or more of such information.

The central control system can direct product content to be displayed on one or more displays of one or more display systems that are located relative to the location of a particular customer. The product content is further displayed at the frame profile corresponding to the particular SGS so that the product content is visible through the particular SGS to the customer. Further, the particular SGS is controlled to coordinate the control of one or more lenses to correspond with and/or be synchronized with the frame profile so that the one or more lenses are transparent or otherwise configured so that the customer can see through at least a portion of one or both lenses when the frames of the specific product content intended to be viewed by the particular customer are displayed on the one or more displays. For example, some embodiments provide SGSs having two distinct lenses (e.g., right and left eye). The SGS can be controlled to right and left lenses to both be synchronized with a frame profile of the content, while in other instances, the right and left lenses can be separately synchronized to frame profiles to enable content to appear three-dimensional. Other embodiments employ SGSs with a single lens or “visor” that is continuous to cover both left and right eyes. This single lens configuration can be controlled according to a single frame profile so that the user can simultaneously see through the single lens with both eyes. Still other embodiments using a single lens SGS and can define sub-lenses within the single lens to enable the SGS to be controlled for each eye, which may be used for example to provide 3-D visual effects.

Further, the frame profile is selected so that frames of the product content will not visible, through a different SGS, to a different second customer. In some embodiments, the frame profile of a first product content and the corresponding lens control timing and/or rate of a first SGS are selected and/or controlled based in part on other SGSs that are within a threshold distance and/or orientation of the one or more displays selected to display the first product content and the lens control timing of those other one or more SGSs. The control circuit can, in some implementations, identify when one or more other SGSs are within the threshold distance and/or orientation of the selected displays and can identify the frame profiles and/or lens control timing associated with those other SGSs. Based on the other frame profiles and/or lens control timing associated with these other SGSs, the central control system can control the frame profile of the first product content to be different from those other frame profiles and/or lens control timing so that the lenses of the other SGSs are opaque while frames of the first product content are displayed and the other customers wearing those other SGSs cannot see the frames of the first product content.

Similarly, when other SGSs are not within the threshold distance and/or orientation threshold, the central control system may select substantially any relevant frame profile for the first content. In some embodiments, however, the central control system may take into consideration other customers wearing SGSs and their expected route of travel through the shopping facility when selecting frame profiles for the first product content and/or the lens control timing. For example, the central control system may identify that a second customer may enter into the threshold distance and/or orientation of the displays while displaying the first content, and can select and/or adjust a frame profile and associated lens control timing for the first product content and the first SGS so that the second customer with the second SGS cannot view the frames of the first product content if the second customer enters into an area within the threshold distance from the one or more displays displaying frames of the first product content. Additionally or alternatively, the control circuit can cause the lens control rate of the second SGS to be changed as the second customer approaches the threshold boundary corresponding to the display or displays displaying the first product content, and when relevant can similarly cause a change in frame profile of a second product content to correspond with the lens timing of the second SGS so that the second product content can continue to be visible to the second customer as the second customer approaches and/or enters the threshold boundary associated with the first SGS.

Further, by controlling the timing of displayed frames of different content and similarly controlling lenses of different SGSs, some embodiments enable different content to be displayed on the same display (or displays) while different customers are both looking at the display (or displays) while each customer only sees those frames of the content intended for the respective customer. For example, in some embodiments the central control system can direct a first content to be displayed on a display at a first frame profile that corresponds with lens control timing of a first SGS associated with a first customer such that the first content is visible through the first SGS to the first customer while not being visible to a second customer through a second SGS. Further, the central control system can direct a second content to be displayed on the same display but at a different frame profile so that the frames of the second content are displayed interleaved with displayed frames of the first content. The different frame profile of the second content further corresponds with lens control timing of the second SGS such that the second content is visible to the second customer through the second SGS that is synchronized with the second frame profile while the second content is not visible to the first customer through the first SGS because the lenses of the first SGS are opaque or otherwise inhibit the first customer's view at least during those times when the frames of the second content are displayed on the display.

As described above, the central control system can be configured to associate and/or can receive information of the association of SGSs with specific customers. In some instances, the central control system can receive sensor data with SGS identifier information of a specific SGS and can further receive sensor information that is used to identify a customer that has retrieved or is provided the specific SGS. For example, an RFID tag of the specific SGS can be received that identifies the SGS, and the specific SGS may be distributed through a kiosk to the customer in response to the customer providing identifying information (e.g., swiping a customer card, swiping a credit card, facial recognition, entering a specific code or pin associated with the customer, detecting a user interface unit 2314 associated with a customer, other such identifying information or combination of such information). Additionally or alternatively, the SGS distribution system 2312 can obtain relevant SGS identifier information and communicate that information to the central control system. In some embodiments, the SGS distribution system may also obtain customer identifier information and communicate that information to the central control system and/or an SGS database that maintains information about the SGSs, associated customer identifiers, status information, operating condition information and/or other relevant information that can be used by the central control system and/or SGS distribution system.

Some embodiments enable multiple SGSs to be associated with a single content and/or a single customer so that multiple different customers can simultaneously view the same content displayed through one or more display systems. The central control system can, in some embodiments, identify that a first customer is associated with one or more other customers. For example, a first customer may be a mother and the one or more other customers may be her child or children. Similarly, two friends may want to shop together so the central control system can identify these customers want to be associated. The association may be based on sensor information (e.g., facial recognition, image processing over time to identify two customers shopping together (e.g., enter within threshold times, continue to be within threshold distances of each other over time, etc.), detecting a communication from user interface units associated with two customers to identify the customers and determining based on customer profiles a relationship (e.g., family, friends, etc.) between two customers, etc.), based on a request by the customer (e.g., through the SGS distribution system or through an application (APP) operated on a customer's user interface unit 2314 selecting an option to distribution to one customer multiple SGSs, selecting of an option to associate multiple SGSs, receiving a request by a second customer to be associated with a first customer, etc.), other such methods, or combination of two or more of such methods. The central control system may associate multiple SGSs with a single customer or may associate multiple SGSs with different customers while defining a relationship or association between the different SGSs and/or different customers. When associated, the central control system can control frame profiles of a content and lens control timing of the multiple SGSs to be synchronized at least during some periods of time while the associated customers are shopping. This allows multiple SGSs to be synchronized over at least a period of time with the frame profile a content such that the multiple customers see the same content during the period of time when the multiple customers are looking at the same display at the same time.

In other instances, however, the central control system can control the frame profile of different content and the lens control timing of the multiple SGSs during one or more other periods of time so that the multiple customers, even though associated, see different content on the same or different displays. This allows the system 2300 to customize content specific to each of the customers even when the customers are associated. The customization can include displaying different products over the same one or more displays, or displaying similar or the same products with different product characteristics (e.g., size, color, count, etc.). For example, a wife and husband may be shown separate product content that actually shows the same products but with different characteristics based on value vectors, preferences and the like associated with each of the wife and the husband (e.g., products displayed in pastel colors for one customer, while the same products are displayed in earth tone colors).

Accordingly, some embodiments identify product content based on an identified customer. The central control system can identify products of interest to a particular customer based on an identification of that customer and a customer profile corresponding to that customer. Based on the identified products of interest, the central control system and/or a product content system can identify the one or more product content that correspond to at least one of the products of interest. The identified product content selected may further be selected based on one or more other factors, such as but not limited to a location of the customer within the shopping facility, content previously viewed by the customer, customer's reaction to previous content (which may include previous advertisement content displayed to the customer), customer's purchase history, customer's shopping history, other such information, or a combination of two or more of such information.

In some embodiments, the displayed content can include virtual renderings on one or more displays of a set of one or more products. Further, in some instances, the virtual rendering displays a set of one or more products three-dimensionally positioned on a set of one or more rendered virtual shelves that when displayed appear to extend along at least a portion of an aisle such that when visible through an SGS depicts a portion of a virtual sales floor of a retail shopping facility with the set of virtual products corresponding to multiple of the products of interest, and which are typically available for purchase through the shopping facility. Accordingly, in some applications the virtually rendered products can display a virtual aisle of products from which the customer can select one or more products. The customer can move along the aisle and select one or more of the displayed products, such as by touching the display on a displayed product, detecting a direction the customer is looking for more than a threshold period of time, etc. The display system can detect the touch and based on a location of the touch the system can identify the product being touched. Some embodiments further display options to the customer in response to the touching or other selection (e.g., option to select a quantity, option to select a size, option to select a quantity, option to select a color, option to get additional information about a product, option to compare one or more products, option to request delivery of a product, other such options, or combination of two or more options). In some instances, some or all of the options may be displayed through a user interface unit associated with the customer.

The virtually displayed set of products can be different for different customers, and through the control of the frame profile and synchronization of the SGSs with the frame profiles, multiple customers can be looking at the same display or set of displays and see different virtual sets of products on the displays. The central control system can direct a first content of a set of one or more products to be displayed on a first set of one or more displays based on a first frame profile, and can further cause a different content to be displayed on at least the set of displays at a different frame profile such that the second content is visible through a second SGS to a second customer while not being visible to the first customer through the first SGS. The second content can include virtual renderings on the same set of one or more displays of a second set of multiple products three-dimensionally positioned on a second set of multiple rendered shelves appearing to extend along at least a portion of the aisle such that when visible through the second SGS depicts a portion of the virtual sales floor of the retail shopping facility. Further, the second set of the multiple products are rendered in a same physical location as the first set of multiple products while both the first customer and the second customer are simultaneously looking at the first set of one or more displays.

Further, in some applications, the displays may be configured to be controlled to be transparent during some periods of time and to display content during other periods of time. Such displays may be doors behind which actual products are stored and available to be retrieved by customers. Typically, the actual products are different that virtual products that are displayed on the display. This allows the central control system to control the displays and a customer's SGS so that the lens control timing is synchronized with a frame profile where the displays are transparent allowing a customer to see through the displays to actual products. Additionally or alternatively, some embodiments are configured to control the displays so that customers that are not wearing SGSs can view the products behind the displays and the display of virtual products are at a rate that does not interfere with the customer's viewing products behind the displays. By incorporating displays in front of actual products, the number of products and/or types of products available to customers for purchase can be significantly increased relative to the actual sales floor space that is occupied by the actual products.

In some embodiments, instructions and/or commands can be communicated to the SGSs to synchronize the lens control timing of the SGSs with the corresponding content intended to be viewed through the SGSs. The central control system can be configured to determine the frame profile at which content is to be rendered on one or more displays. Based on the frame profile, the central control system can cause one or more synchronization signals to be communicated to an SGS specifying at least the frame profile and/or lens control timing that enables a synchronization of the control of the lenses of the SGS with the frame profile of the content being displayed. As described above, the frame profile and thus the rate of control of the lenses can be varied over time while a customer is using an SGS. In some embodiments, for example, the central control system can cause a modulation over time of a frame profile in rendering a content in accordance with a modulation sequence. The modulation sequence can, for example, define different frame profiles and timing regarding when to apply the different frame profiles, can define code used to calculate a frame profile, or other such sequence. In some instances, the modulation sequence can be communicated to a set of one or more display systems that implement the modulation of the frame profile in accordance with the modulation sequence. In other instances, the central control system communicates instructions based on the sequence to cause the changes. In still other instances, one or more content sources can be controlled according to the modulation sequence in distributing frames in accordance with the modulation sequence. Further, in some embodiments, the central control system can cause lens control timing sequences cause a modulation over time of the lens control timing in accordance with the modulation sequence and/or a corresponding lens control timing sequence to provide synchronization between the SGS and the one or more display systems. For example, in some instances, one or more synchronization signals with respective SGSs further specify the modulation sequence to cause respective SGSs to modulate the control of the lenses of the SGS in synchronization with the changing frame profiles.

By virtually displaying products content (e.g., virtually rendered products, advertising of products, product information, etc.), the system can greatly increase the numbers of products that may be available for consideration by customers relative to an amount of actual physical floor area that would otherwise have to be available to support the products in a way that customers could retrieve the products. In some embodiments, the physical products displayed through the display systems can be stored in one or more storage locations. The storage locations can be more compact than would typically be positioned on a sales floor, can be stacked at levels that are higher than on sales floors, and the like, allowing a more optimized use of storage space and sales floor space. In some embodiments, when a customer selects a product to be purchased, a display system and/or a detection system can notify a worker and/or a retrieval system to cause the actual product to be retrieved from a storage location and subsequently provided to the customer, which may be prior to the customer leaves the shopping facility or through a delivery at a delivery location (e.g., home delivery, office delivery, etc.).

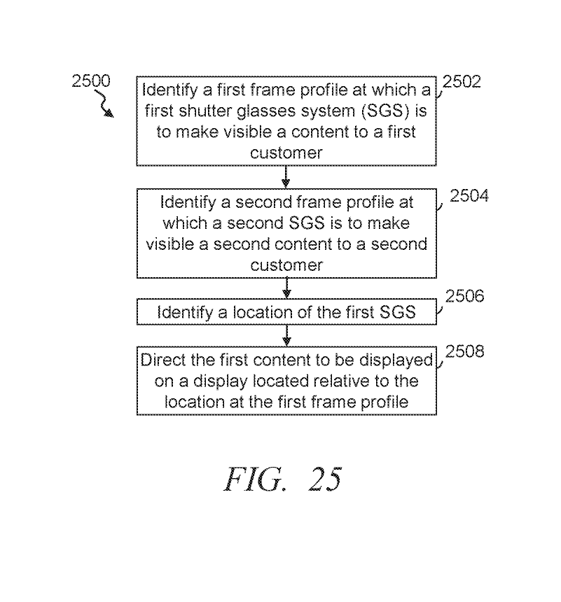

FIG. 25 illustrates a simplified block diagram of an exemplary process 2500 of providing a customized retail shopping experience for customers at a shopping facility, in accordance with some embodiments. In step 2502, a frame profile is identified at which an active first SGS of a plurality of SGSs is to make visible a first product content intended for a first customer or one or more customers. As described above, each of a set of a plurality of SGSs includes controllable lenses and is configured to selectively control rates of when one or both of the lenses are opaque and when one or both of the lenses are transparent.

In step 2504, a different second frame profile is identified at which a second SGS of the plurality of SGSs is to make visible a second product content intended for a second customer. The second product content is typically different content than the first content, however, in some instances it may be the same, such as in some applications the same content may be displayed at a different time. In step 2506, location of the first SGS while within the shopping facility is identified. Some embodiments further identify direction the SGS is facing and/or identify a direction the customer is looking. In step 2508, the first product content is directed to be displayed on at least a first display located relative to the location of the first SGS and at the first frame profile such that the first product content is visible through the first SGS to the first customer while not being visible to the second customer through the second SGS.

The first customer while at the shopping facility can be associated with the first SGS of the plurality of SGSs. Similarly, the second customer while at the shopping facility can be associated with the second SGS. In some instances, one or more other SGSs may also be associated with one of the first or second SGSs. When multiple SGSs are associated with a single customer (e.g., the first customer), the SGSs associated with the first customer can be synchronized so that each customer wearing one of the SGSs associated with the first customer may each see the first content on the first display. In other instances, the SGSs associated with a single customer may operate a different lens control timing, such as when located at a distance from the first customer. Further, some embodiments may at least temporarily associate different customers together and the SGSs being used by those customers. The system can identify that the first customer is associated with a third customer. A third SGS of the plurality of SGSs can be associated with the third customer while at the shopping facility, and the first SGS and the third SGS can be synchronized over at least a period of time with the first frame profile of the first product content such that the first customer and the third customer see the same first product content during the period of time when both the first customer and the third customer are looking at the first display.

Further, in some implementations, multiple different content can be displayed on a single display or set of displays while each of the multiple different content can be associated and viewed by a different one of the customers through respective SGSs. For example, a first product content can be directed to be displayed on at least a first display at a first frame profile, and a second product content can be directed to be displayed on at least the first display at a second frame profile. The second product content can be displayed with frames of the second content interleaved at least with frames of the first product content. As such, the second product content can be visible to the second customer through the second SGS synchronized with the second frame profile while the second product content is not visible to the first customer through the first SGS. In some applications, a single SGS may be at least temporarily synchronized with multiple different frame profiles associated with different contents such that a customer wearing that SGS can view multiple different displayed contents (e.g., displayed representations of products provided through a first content at a first frame profile, in addition to a second content, such as product information, sale information, highlighting and/or other such content, that is displayed at a different second frame profile and interleaved with the first content.

The content to be displayed can in part be dependent on the customer viewing the content. Some embodiments identify products of interest to a customer based on an identification of the customer and a customer profile corresponding to the customer. Product content that is to be displayed to the customer can be identified that correspond to at least one of the products of interest. In some embodiments, the central control system accesses one or more databases storing value vector information corresponding to a customer and uses one or more of these value vectors to identify one or more products in which the customer is predicted to more likely purchase and/or be interested.

In directing content to be displayed on one or more displays, some embodiments cause virtual renderings on the one or more displays of a set of multiple products. Further, the products may be rendered to appear as three-dimensional. In some instances, the displayed products may visually appear to be three-dimensionally positioned on a set of one or more rendered shelves and/or appearing to extend along at least a portion of an aisle such that when visible through an SGS depicts a portion of a virtual sales floor of a retail shopping facility with the set of multiple products, where one or more of the rendered products may further correspond to one or more of products of interest to the customer viewing the displayed content through the SGS. In some instances, a second product content can be directed to be displayed on at least one of the displays used to display the first content, at a second frame profile such that the second product content is visible through a second SGS to a second customer while not being visible to the first customer through the first SGS. Again, virtual renderings of the a second set of multiple products on the one or more displays may be displayed to appear as being three-dimensionally positioned on a second set of multiple rendered shelves appearing to extend along at least a portion of the aisle such that when visible through the second SGS depicts a portion of the virtual sales floor of the retail shopping facility. Further, the second set of the multiple products may be rendered in a same physical location as the first set of multiple content while both the first customer and the second customer are simultaneously looking at the same display upon which the first and second content are being rendered in accordance with respective frame profiles.

As described above, the SGSs are typically synchronized with respective frame profiles of content to be viewed through the respective SGSs. In some embodiments, the frame profile at which a first content is to be rendered is selected and/or determined. The rate may depend on one or more factors, such as but not limited to a number of SGSs being used, locations of the SGS and/or other SGSs in use, types of content and/or products being displayed, expected duration content is expected to be displayed (e.g., based on customers' shopping habits, type of product, factors to consider about the product, cost of the product, etc.), a modulation of the frame profile, other such factors, or combination of two or more of such factors. A synchronization signal can be caused to be communicated to the SGS specifying at least the frame profile. The synchronization signal is configured to be used by the SGS control circuit to synchronize the control of the lenses with the frame profile of the content. Again, some embodiments cause the frame profile to modulate over time in rendering the content in accordance with a modulation sequence. The synchronization signal can be configured to specify the modulation sequence to cause the SGS to modulate the control of the lenses of the SGS in accordance with the modulation sequence.

In some embodiments, there is provided a system providing a customized retail shopping experience, comprising: a plurality of active shutter glasses systems (SGS) each comprising controllable lenses, wherein each of the plurality of SGSs is configured to selectively control rates of when one or both of the lenses are opaque and when one or both of the lenses are transparent; and a central control system of a retail shopping facility that is separate from and in wireless communication with each of the plurality of SGSs and comprises a central control circuit coupled with memory storing code that when implemented by the central control circuit causes the central control circuit to: identify a first frame profile at which a first SGS is to make visible a first product content intended for a first customer, and identify a different second frame profile at which a second SGS is to make visible a second product content intended for a second customer; identify a first location of the first SGS while within the shopping facility; and direct the first product content to be displayed on at least a first display located relative to the first location at the first frame profile such that the first product content is visible through the first SGS to the first customer while not being visible to the second customer through the second SGS.

Further implementations of these embodiments are provided. For example, in some implementations, the central control system is configured to direct the second product content to be displayed on at least the first display at the second frame profile and interleaved with at least the first product content such that the second product content is visible to the second customer through the second SGS synchronized with the second frame profile while the second product content is not visible to the first customer through the first SGS. In some embodiments, the central control circuit is configured to associate the first customer at the shopping facility with the first SGS of the plurality of SGSs and associate the second customer at the shopping facility with the second SGS of the plurality of SGSs. In some embodiments, the central control circuit is configured to: identify that the first customer is associated with a third customer; associate a third SGS of the plurality of SGSs with the third customer while at the shopping facility; and cause the first SGS and the third SGS to be synchronized over at least a period of time with the first frame profile of the first product content such that the first customer and the third customer see the same first product content during the period of time when both the first customer and the third customer are looking at the first display. In some embodiments, the central control circuit is configured to identify products of interest to the first customer based on an identification of the first customer and a first customer profile corresponding to the first customer, and to identify the first product content that correspond to at least one of the products of interest. In some embodiments, the first product content comprises virtual renderings on the first display of a first set of multiple products three-dimensionally positioned on a first set of multiple rendered shelves appearing to extend along at least a portion of an aisle such that when visible through the first SGS depicts a portion of a virtual sales floor of a retail shopping facility with the first set of multiple products corresponding to multiple of the products of interest. In some embodiments, the central control circuit is configured to direct the second product content to be displayed on at least the first display at the second frame profile such that the second product content is visible through the second SGS to the second customer while not being visible to the first customer through the first SGS, wherein the second product content comprises virtual renderings on the first display of a second set of multiple products three-dimensionally positioned on a second set of multiple rendered shelves appearing to extend along at least a portion of the aisle such that when visible through the second SGS depicts a portion of the virtual sales floor of the retail shopping facility, wherein the second set of the multiple products are rendered in a same physical location as the first set of multiple products while both the first customer and the second customer are simultaneously looking at the first display. In some embodiments, the central control circuit is configured to determine the first frame profile at which the first product content is to be rendered, and cause a synchronization signal to be communicated to the first SGS specifying at least the first frame profile and cause a synchronization of the control of the lenses with the first frame profile of the first product content. In some embodiments, the central control circuit is configured to cause a modulation over time of the first frame profile in rendering the first product content in accordance with a modulation sequence, wherein the synchronization signal further specifies the modulation sequence causing the first SGS to modulate the control of the lenses of the first SGS.

In some embodiments, there is provided a method providing a customized retail shopping experience, comprising: by a central control system of a retail shopping facility: identifying a first frame profile at which a first active shutter glasses system (SGS) of a plurality of SGSs is to make visible a first product content intended for a first customer, wherein each of the plurality of SGSs comprises controllable lenses and is configured to selectively control rates of when one or both of the lenses are opaque and when one or both of the lenses are transparent; identifying a different second frame profile at which a second SGS of the plurality of SGSs is to make visible a second product content intended for a second customer; identifying a first location of the first SGS while within the shopping facility; and directing the first product content to be displayed on at least a first display located relative to the first location at the first frame profile such that the first product content is visible through the first SGS to the first customer while not being visible to the second customer through the second SGS.

Further implementations of these embodiments are provided. For example, in some implementations, the method further comprises: directing the second product content to be displayed on at least the first display at the second frame profile and interleaved with at least the first product content such that the second product content is visible to the second customer through the second SGS synchronized with the second frame profile while the second product content is not visible to the first customer through the first SGS. In some embodiments, the method further comprises: associating the first customer at the shopping facility with the first SGS of the plurality of SGSs; and associating the second customer at the shopping facility with the second SGS of the plurality of SGSs. In some embodiments, the method further comprises: identifying that the first customer is associated with a third customer; associating a third SGS of the plurality of SGSs with the third customer while at the shopping facility; and causing the first SGS and the third SGS to be synchronized over at least a period of time with the first frame profile of the first product content such that the first customer and the third customer see the same first product content during the period of time when both the first customer and the third customer are looking at the first display. In some embodiments, the method further comprises: identifying products of interest to the first customer based on an identification of the first customer and a first customer profile corresponding to the first customer; and identifying the first product content that correspond to at least one of the products of interest. In some embodiments, the directing the first product content to be displayed on at least the first display comprises causing virtual renderings on the first display of a first set of multiple products three-dimensionally positioned on a first set of multiple rendered shelves appearing to extend along at least a portion of an aisle such that when visible through the first SGS depicts a portion of a virtual sales floor of a retail shopping facility with the first set of multiple products corresponding to multiple of the products of interest. In some embodiments, the method further comprises: directing the second product content to be displayed on at least the first display at the second frame profile such that the second product content is visible through the second SGS to the second customer while not being visible to the first customer through the first SGS; and causing virtual renderings on the first display of a second set of multiple products three-dimensionally positioned on a second set of multiple rendered shelves appearing to extend along at least a portion of the aisle such that when visible through the second SGS depicts a portion of the virtual sales floor of the retail shopping facility, wherein the second set of the multiple products are rendered in a same physical location as the first set of multiple products while both the first customer and the second customer are simultaneously looking at the first display. In some embodiments, the method further comprises: determining the first frame profile at which the first product content is to be rendered; and causing a synchronization signal to be communicated to the first SGS specifying at least the first frame profile and causing a synchronization of the control of the lenses with the first frame profile of the first product content. In some embodiments, the method further comprises: causing the first frame profile to modulate over time in rendering the first product content in accordance with a modulation sequence, wherein the synchronization signal further specifies the modulation sequence causing the first SGS to modulate the control of the lenses of the first SGS.

In another form that may use partiality vectors and vectorized characterizations, there is provided a retail shopping facility having a product display area where a plurality of categorically-different representative products are physically disposed such that a customer can selectively and without retailer supervision physically interact with such representative products. The product display area also includes at least one user interface that operably couples to a control circuit. This control circuit serves to present customization options regarding at least some of the plurality of categorically-different representative products and to receive user selections of at least one customization option for a particular one of the plurality of categorically-different representative products.

So configured, a customer in the product display area is able to physically interact with representative products in which the customer has interest. This customer can also readily understand how particular representative products can be customized and select particular customizations to be applied to a particular product they select to purchase. These teachings permit a customized product fulfillment apparatus that minimizes physical retail product display space while providing a customer with an immediate opportunity to physically inspect any of a plurality of categorically-different representative products.

By one approach the aforementioned representative products each serve to physically represent a corresponding plurality of differently-branded categorically-alike products. As one illustrative approach in these regards one or more of the representative products serve as generic representations for such differently-branded categorically-alike products.

These teachings are highly flexible in practice and will accommodate a variety of modifications and/or supplemental features. By one approach, for example, the aforementioned customization options are product options provided by a corresponding manufacturer of a particular representative product. By another approach, the customization options are product options provided by a post-manufacturer customizer of a particular representative product (including but not limited to the enterprise that operates the aforementioned retail shopping facility).

These and other benefits may become clearer upon making a thorough review and study of the following detailed description. Referring now to the drawings, an illustrative apparatus that is compatible with many of these teachings will now be presented.

In this illustrative example the enabling apparatus includes at least one retail shopping facility 2601. This retail shopping facility 2601 comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

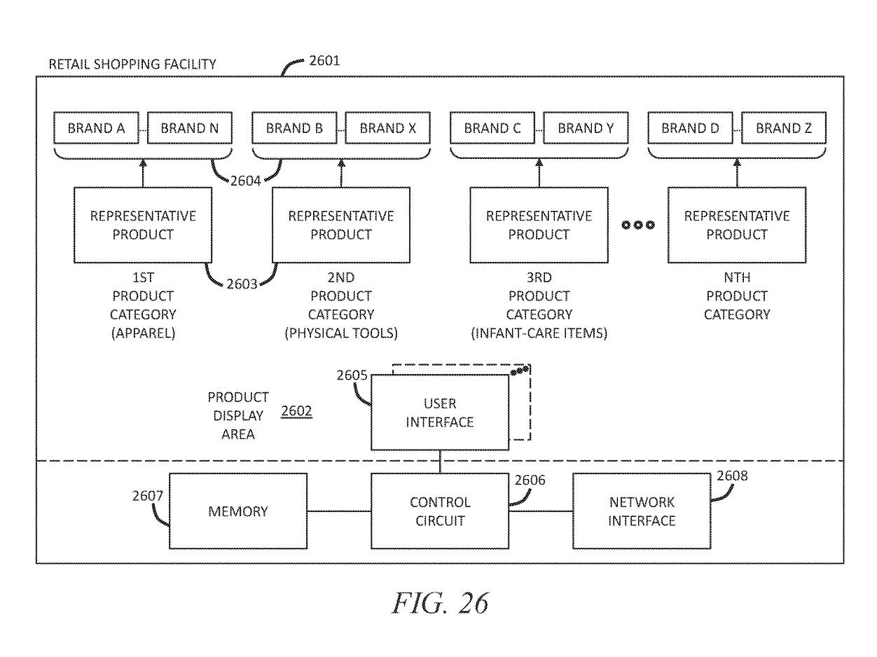

The retail shopping facility 2601 also includes at least one product display area 2602. This product display area 2602 is a physical area that is sufficiently sized to contain a plurality of representative products 2603. These representative products 2603 each pertain to a categorically-different product category. As a simple example in these regards, in FIG. 26 one of the representative products corresponds to a first product category pertaining to apparel while a second representative product corresponds to a second product category pertaining to physical tools. As yet another example, another of the representative products corresponds to a third product category pertaining to infant-care items, and so forth.

The product categories can be generalized as shown in these specific examples. These teachings will also accommodate, however, further specie isolation within a particular product category to drill down to sub-product categories. For example, these teachings will accommodate a first product category corresponding to apparel/pants and a second product category corresponding to apparel/blouses if desired.

These representative products are themselves physical items. A representative product for a product category of “laptop computers” with therefore itself constitute a laptop computer. By one approach these categorically-different representative products 2603 are physically disposed within the product display area 2602 such that a customer can selectively and without retailer supervision physically interact with such representative products 2603. So, for example, the customer can physically touch a representative laptop computer.

These representative products 2603 may, or may not, be the actual item that a customer can purchase. Regardless of whether the representative product can be purchased by the customer, these representative products each serve to physically represent a corresponding plurality of differently-branded categorically-alike products 2604. This representative capacity exists regardless of whether the particular representative product is itself a branded item. If desired, these teachings will accommodate using a generic representation of a particular product category as the representative product 2603 for that product category. These teachings will accommodate having only some of the representative products 2603 serve in the aforementioned capacity or a majority of the representative products 2603 can serve in these regards as described.

To continue with the simple example offered above, when the product category comprises laptop computers and the representative product 2603 for that product category comprises either a generic example of a laptop computer or a branded laptop computer, that representative product 2603 serves as a physical stand in or an avatar of sorts for any number of other laptop computers bearing various brands as manufactured and/or offered by a variety of manufacturers and distributors. Accordingly, these teachings will accommodate using a laptop computer manufactured by a first manufacturer as a representative product for laptop computers made by one or more other manufacturers.

The foregoing applies notwithstanding the non-displayed products will likely include attributes and features not available in the corresponding representative product 2603. It will therefore be understood that the representative product 2603 is not intended, nor should it be represented as, constituting a full, accurate, and/or fair representation of all available brands. That said, however, the representative product 2603 can serve as a useful and intuitive physical starting point for a customer interested in exploring available offerings and options for such a product category.

In this illustrative example the product display area 2602 also includes at least one user interface 2605. This user interface 2605 comprises any of a variety of user-input mechanisms (such as, but not limited to, keyboards and keypads, cursor-control devices, touch-sensitive displays, speech-recognition interfaces, gesture-recognition interfaces, and so forth) as well as at least one user-output mechanism (such as, but not limited to, visual displays, audio transducers, printers, and so forth) to facilitate receiving information and/or instructions from a user and/or providing information to a user. For the sake of an illustrative example it will be presumed here that the user interface comprises a touch-screen device.

By one approach the user-interface 2605 is an integral part of the retail shopping facility 2601 and is provided for the temporary use and benefit of visiting customers. These teachings will also accommodate, however, permitting customers to use their own devices (such as their so-called smart phones or pad/table-styled computers) to serve as the customer edge of the user interface 2605. To facilitate the latter approach the customer's device may communicate wirelessly (using, for example, Wi-Fi or Bluetooth-compatible communications) with the enterprise that operates the retail shopping facility 2601.

In this particular example, the enabling apparatus also includes a control circuit 2606 that operably couples to the aforementioned user interface 2605. Being a “circuit,” the control circuit 2606 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 2606 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 2606 is configured (for example, by using corresponding programming as will be well understood by those skilled in the art) to carry out one or more of the steps, actions, and/or functions described herein.

By one optional approach the control circuit 2606 operably couples to a memory 2607. This memory 2607 may be integral to the control circuit 2606 or can be physically discrete (in whole or in part) from the control circuit 2606 as desired. This memory 2607 can also be local with respect to the control circuit 2606 (where, for example, both share a common circuit board, chassis, power supply, and/or housing) or can be partially or wholly remote with respect to the control circuit 2606 (where, for example, the memory 2607 is physically located in another facility, metropolitan area, or even country as compared to the control circuit 2606).

This memory 2607 can serve, for example, to non-transitorily store the computer instructions that, when executed by the control circuit 2606, cause the control circuit 2606 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

The control circuit 2606 can also optionally operably couple to a network interface 2608. So configured the control circuit 2606 can communicate with other elements (both within the apparatus and external thereto) via the network interface 2608. Network interfaces, including both wireless and non-wireless platforms, are well understood in the art and require no particular elaboration here.

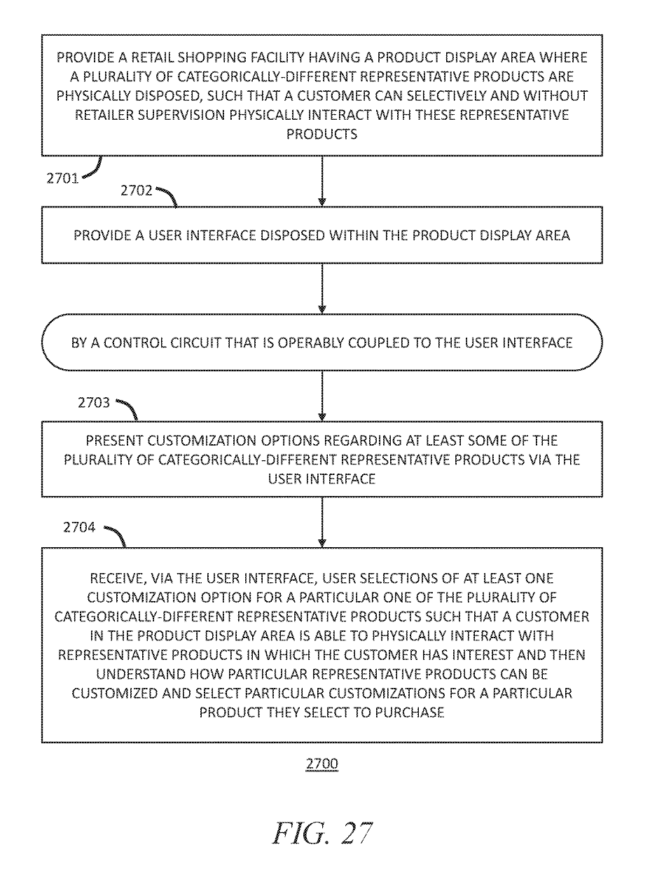

FIG. 27 presents a process 2700 that also accords with the present teachings. At block 2701 this process 2700 provides a retail shopping facility 2601 as described above that includes a product display area 2602 where a plurality of categorically-different representative products 2603 are physically disposed such that a customer can selectively and without retailer supervision physically interact with these representative products 2603. Block 2702 then provides the aforementioned user interface 2605 within the product display area 2602.

The remaining activities of this process 2700 can be carried out, by one approach, by the aforementioned control circuit 2606.

At block 2703 the control circuit 2606 presents customization options regarding at least some of the plurality of categorically-different representative products 2603 via the user interface 2605. These customization options can comprise, for example, options that are offered by the manufacturers of the represented products. By another approach, in lieu of the foregoing or in combination therewith, the customization options can comprise options that are offered by a post-manufacturer customizer (including but not limited to the enterprise that operates the aforementioned retail shopping facility 2601).

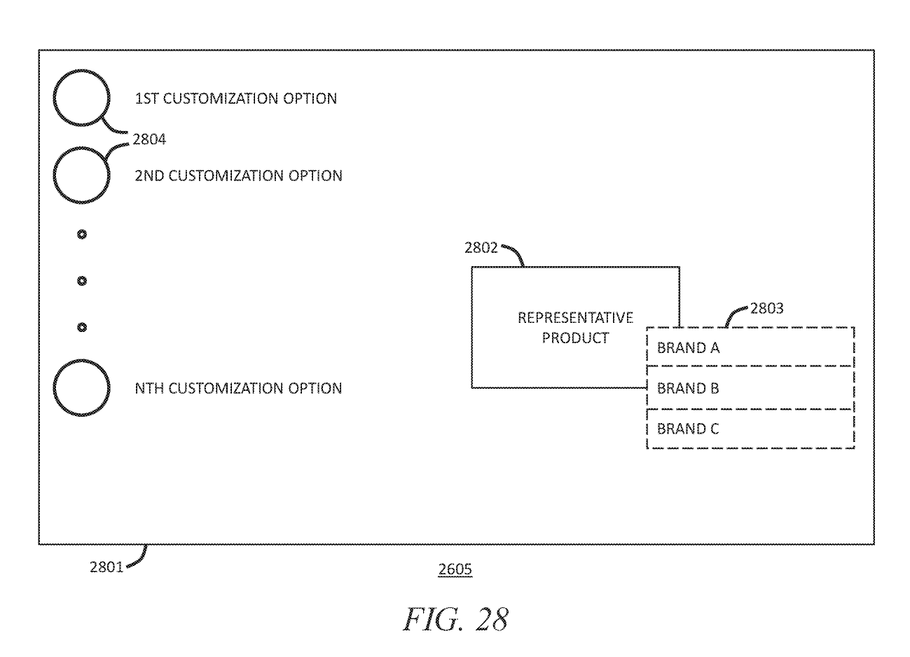

FIG. 28 provides an illustrative example in these regards. In particular, FIG. 28 presents a simple schematic representation of a screenshot appearing on the display 2801 of a particular customer's user interface 2605. In this particular example the displayed content includes a representative for the product 2802 of interest. When, for example, the user interface 2605 comprises a part of a kiosk that physically holds or otherwise displays a particular representative product 2603, the user interface 2605 can present a virtual representation of that representative product as well.

The user interface 2605 can present any of a wide variety of static or interactive items by which the customer can learn more regarding particular products and/or their availability, price, and so forth. As one simple example in these regards, and with continued reference to FIG. 28, the customer may interact with the onscreen-displayed representative product 2802 to thereby cause a listing 2803 of available brands for that particular representative product 2802 to be displayed. This simple example is only offered to illustrate that any number of content possibilities are available and can be supported by the present teachings.

As noted above, however, the control circuit 2606 presents customization options regarding categorically-different representative products. In FIG. 28 the control circuit 2606 meets this requirement by presenting user-assertable buttons 2804 that each correspond to a particular customization options. By one approach, this presentation can include brief textual or non-textual descriptions of the customization possibility. For example, when the representative product pertains to the category of laptop computers, available customization options may include color choices, memory capacity, central processor architecture or specific processor integrated circuits, USB ports, optical disk drives, screen sizes, touchpads, touchscreen capability, and so forth.

Then, at block 2704, the control circuit 2606 receives, via the user interface 2605, user selections of at least one customization option for a particular one of the plurality of categorically-different representative products 2603. By one approach, the customer can choose various customizations without first having selected a particular brand of product. In this case, the control circuit 2606 may then present to the customer those branded products within the relevant product category as the representative product that comport with the selected options. The customer can then choose from amongst those available products to make their purchasing selections.

So configured, this customer is able to physically interact with representative products in which the customer has interest to better understand how particular representative products can be customized and to select particular customizations for a particular product they select to purchase. Such an approach can provide the customer with access to a vast array of candidate products while also enjoying the benefit of physically interacting with a representative product of the general product category of interest. To some large extent these teachings provide the best of both physical shopping and on-line shopping by providing a physical nexus and experience in combination with an inventory of products beyond that which many physical retail shopping facilities can reasonably contain.

By one approach the customization options provided per the foregoing process are the same for all customers. These teachings are highly flexible in practice, however, and will accommodate other approaches in these regards. For example, by one approach the particular customization options presented to a given customer can be dynamically selected to accord with that particular customer's partialities, as addressed above.

In some embodiments, there is provided a customized product fulfillment apparatus to minimize physical retail product display space while providing a customer with an immediate opportunity to physically inspect any of a plurality of categorically-different representative products, the apparatus comprising: a retail shopping facility having a product display area where a plurality of categorically-different representative products are physically disposed, such that a customer can selectively and without retailer supervision physically interact with such representative products; a user interface disposed within the product display area; a control circuit operably coupled to the user interface and configured to: present customization options regarding at least some of the plurality of categorically-different representative products via the user interface; receive, via the user interface, user selections of at least one customization option for a particular one of the plurality of categorically-different representative products; such that a customer in the product display area is able to physically interact with representative products in which the customer has interest and then understand how particular representative products can be customized and select particular customizations for a particular product they select to purchase.

Further implementations of these embodiments are provided. For example, in some implementations, at least some of the representative products are generic representations. In some embodiments, at least some of the representative products each serve to physically represent a corresponding plurality of differently-branded categorically-alike products. In some embodiments, at least a majority of the representative products each serve to physically represent a corresponding plurality of differently-branded categorically-alike products. In some embodiments, at least some of the customization options are product options provided by a corresponding manufacturer of a particular represented product. In some embodiments, at least some of the customization options are product options provided by a post-manufacturer customizer of a particular represented product. In some embodiments, at least some of the plurality of categorically-different representative products correspond to apparel. In some embodiments, at least some of the plurality of categorically-different representative products correspond to physical tools. In some embodiments, at least some of the plurality of categorically-different representative products correspond to infant-care items. In some embodiments, there is only one of the representative products in the product display area for each of a plurality of different categories of products.

In some embodiments, there is provided a customized product fulfillment method that minimizes physical retail product display space while providing a customer with an immediate opportunity to physically inspect any of a plurality of categorically-different representative products, the method comprising: providing a retail shopping facility having a product display area where a plurality of categorically-different representative products are physically disposed, such that a customer can selectively and without retailer supervision physically interact with such representative products; providing a user interface disposed within the product display area; by a control circuit that is operably coupled to the user interface: presenting customization options regarding at least some of the plurality of categorically-different representative products via the user interface; receiving, via the user interface, user selections of at least one customization option for a particular one of the plurality of categorically-different representative products; such that a customer in the product display area is able to physically interact with representative products in which the customer has interest and then understand how particular representative products can be customized and select particular customizations for a particular product they select to purchase.

Further implementations of these embodiments are provided. For example, in some implementations, at least some of the representative products are generic representations. In some embodiments, at least some of the representative products each serve to physically represent a corresponding plurality of differently-branded categorically-alike products. In some embodiments, at least a majority of the representative products each serve to physically represent a corresponding plurality of differently-branded categorically-alike products. In some embodiments, at least some of the customization options are product options provided by a corresponding manufacturer of a particular represented product. In some embodiments, at least some of the customization options are product options provided by a post-manufacturer customizer of a particular represented product. In some embodiments, at least some of the plurality of categorically-different representative products correspond to apparel. In some embodiments, at least some of the plurality of categorically-different representative products correspond to physical tools. In some embodiments, at least some of the plurality of categorically-different representative products correspond to infant-care items. In some embodiments, there is only one of the representative products in the product display area for each of a plurality of different categories of products. In some embodiments, the method further comprises: selecting at least one of the customization options to present to the customer as a function, at least in part, of partiality vectors for the customer.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801, filed Apr. 18, 2017; 62/510,322, filed May 24, 2017; 62/510,317, filed May 24, 2017; Ser. No. 15/606,602, filed May 26, 2017; 62/513,490, filed Jun. 1, 2017; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017.

What is claimed is:

1. A system for locating customers in shopping facilities comprising:
an electronic interface configured to receive a customer's request for a product at a shopping facility;
at least one sensor configured to determine and monitor the customer's location in the shopping facility;
a control circuit operatively coupled to the electronic interface and the at least one sensor, the control circuit configured to:
identify the product requested by the customer;
initiate a determination if the product is present at the shopping facility;
if the product is present, provide an instruction to collect the product;
determine the location of the customer in the shopping facility;
monitor the location of the customer as the customer moves through the shopping facility; and
instruct delivery of the collected product to the customer in the shopping facility.

2. The system of claim 1, wherein the electronic interface comprises a mobile device configured to:
scan a product identification label at a shelf in the shopping facility intended to contain the product; and
provide notification that the product is not available at the shelf.

3. The system of claim 1, wherein the electronic interface comprises a kiosk at the shopping facility configured to receive the customer's request for the product.

4. The system of claim 1, wherein the electronic interface comprises a server at the shopping facility configured to receive the customer's request for the product.

5. The system of claim 1, wherein the at least one sensor comprises at least one image capture device configured to identify the customer and monitor the movement of the customer in the shopping facility.

6. The system of claim 1, wherein the at least one sensor comprises an array of audio sensors arranged in a predetermined pattern in the shopping facility and configured to identify the customer and monitor the movement of the customer in the shopping facility.

7. The system of claim 2, wherein:
the mobile device includes monitoring software and is configured to transmit a monitoring signal; and
the at least one sensor comprises a Wi-Fi positioning system configured to receive the monitoring signal and determine the location of the mobile device in the shopping facility.

8. The system of claim 1, wherein:
if the product is not present at the shopping facility, the control circuit is configured to identify a substitute product.

9. The system of claim 8, wherein the control circuit is configured to access a database and identify the substitute product by at least one of:
selecting the substitute product from other products in the same category as the requested product; and
selecting the substitute product from other products previously purchased by the customer.

10. The system of claim 8, wherein the control circuit is configured to identify the substitute product by:
accessing partiality information for the customer and using that partiality information to form corresponding partiality vectors for the customer wherein the partiality vector has a magnitude that corresponds to a magnitude of the customer's belief in an amount of good that comes from an order associated with that partiality.

11. The system of claim 10, wherein the control circuit is further configured to identify the substitute product by:
forming counterpart product vectors for products wherein the counterpart vectors have a magnitude that represents the degree to which each of the products pursues a corresponding partiality.

12. The system of claim 11, wherein the control circuit is further configured to identify the substitute product by:
using at least one of the partiality vectors and the product vectors to determine a product that accords with a given customer's own partialities and identifying that product as the substitute product.

13. The system of claim 1, wherein:
if the product is not present at the shopping facility, the control circuit is configured to communicate to the customer through the electronic interface the option of delivery of the product to the customer's residence or the option of customer pick of the product at a future time.

14. The system of claim 1, wherein if the product is present, the control circuit is configured to inform the customer through the electronic interface that the product will be delivered to the customer in the shopping facility.

15. The system of claim 1, wherein the control circuit is configured to transmit a current location of the customer to a shopping facility employee collecting the product.

16. A method for locating customers in shopping facilities comprising:
receiving, by an electronic interface, a customer's request for a product at a shopping facility;
determining and monitoring, by at least one sensor, the customer's location in the shopping facility;
by a control circuit:
identifying the product requested by the customer;
initiating a determination if the product is present at the shopping facility;
if the product is present, providing an instruction to collect the product;
determining the location of the customer in the shopping facility;
monitoring the location of the customer as the customer moves through the shopping facility; and
instructing delivery of the collected product to the customer in the shopping facility.

17. The method of claim 16, further comprising, by a mobile device:
scanning a product identification label at a shelf in the shopping facility intended to contain the product; and
providing notification that the product is not available at the shelf.

18. The method of claim 16, further comprising, by the control circuit:
if the product is not present at the shopping facility, identifying a substitute product.

19. The method of claim 18, further comprising, by the control circuit, accessing a database and identifying the substitute product by at least one of:
selecting the substitute product from other products in the same category as the requested product;
selecting the substitute product from other products previously purchased by the customer; and
selecting the substitute product from other products corresponding to the customer's preferences and values.

20. The method of claim 16, further comprising, by the control circuit:
if the product is not present at the shopping facility, communicating to the customer through the electronic interface the option of delivery of the product to the customer's residence or the option of customer pick of the product at a future time.

21. The method of claim 16, further comprising, by the control circuit:
if the product is present, informing the customer through the electronic interface that the product will be delivered to the customer in the shopping facility.

22. The method of claim 16, further comprising, by the control circuit, transmitting a current location of the customer to a shopping facility employee collecting the product.

23. A system for delivering products to customers in shopping facilities comprising:
an electronic interface configured to receive a customer's request for a product at a shopping facility;
a control circuit operatively coupled to the electronic interface, the control circuit configured to:
identify the product requested by the customer;
initiate a determination if the product is present at the shopping facility;
if the product is present, provide an instruction to collect the product;
receive a communication from the customer identifying a rendezvous location in the shopping facility; and
instruct delivery of the collected product to the customer at the rendezvous location.
